(19) United States
(12) Patent Application Publication
(10) Pub. No.: US 2010/0222087 A1
(43) Pub. Date: Sep. 2, 2010

(54) SYSTEMS, METHODS AND APPARATUS FOR COMMUNICATING INFORMATION TO A MOBILE DEVICE IN A BROADCAST SIGNAL

(75) Inventor: Bruce Dragt, Marietta, GA (US)

Correspondence Address: SUTHERLAND ASBILL & BRENNAN LLP, 999 PEACHTREE STREET, N.E., ATLANTA, GA, 30309, US

(73) Assignee: FIRST DATA CORPORATION, Greenwood Village, CO (US)

(21) Appl. No.: 12/396,255

(22) Filed: Mar. 2, 2009

(51) Int. Cl. H04W 4/12

(52) U.S. Cl. 455/466

(57) ABSTRACT

Systems, methods, and apparatus for facilitating the communication of information to a mobile device in a broadcast signal are provided. A tone may be inserted into a broadcast signal, the tone including at least one location identifier for information associated with the tone. The broadcast signal may be output for communication to a tone transmission device that is operable to communicate the tone to a mobile device. Once received by the mobile device, the at least one location identifier may facilitate the receipt, by the mobile device from an information source, of the information associated with the tone.

### CROSS-REFERENCE TO RELATED APPLICATIONS

This application is related to U.S. patent application Ser. No. ______ (Attorney Docket No. 34250-1308) filed Mar. 2, 2009 and entitled “Systems, Methods, and Devices for Administering Consumer Rewards Programs Through the Use of Tones Sent to Mobile Devices”; U.S. patent application Ser. No. ______ (Attorney Docket No. 34250-1309) filed Mar. 2, 2009 and entitled “Systems, Methods, and Apparatus for Providing Promotion Information to a Mobile Device”; U.S. patent application Ser. No. ______ (Attorney Docket No. 34250-1310) filed Mar. 2, 2009 and entitled “Systems, Methods, and Apparatus for Marketing by Communicating Tones to a Mobile Device”; U.S. patent application Ser. No. ______ (Attorney Docket No. 34250-1312) filed Mar. 2, 2009 and entitled “Systems, Methods, and Apparatus for Facilitating Communication Between Mobile Devices”; U.S. patent application Ser. No. ______ (Attorney Docket No. 34250-1313) filed Mar. 2, 2009 and entitled “Systems, Methods, and Devices for Prompting Mobile Device Users for Feedback Information Using Tone Transmissions”; U.S. patent application Ser. No. ______ (Attorney Docket No. 34250-1314) filed Mar. 2, 2009 and entitled “Systems, Methods, and Apparatus for Facilitating Transactions Using a Mobile Device”; U.S. patent application Ser. No. ______ (Attorney Docket No. 34250-1315) filed Mar. 2, 2009 and entitled “Systems, Methods, and Apparatus for Providing Terms and Conditions and Program Enrollment Information to a Mobile Device”; U.S. patent application Ser. No. ______ (Attorney Docket No. 34250-1316) filed March 2, 2009 and entitled “Systems, Methods, and Devices for Communicating Supplemental Information to Mobile Devices”; U.S. patent application Ser. No. ______ (Attorney Docket No. 34250-1325) filed March 2, 2009 and entitled “Systems, Methods, and Apparatus for Receiving Information by a Mobile Device”; U.S. patent application Ser. No. ______ (Attorney Docket No. 34250-1326) filed Mar. 2, 2009 and entitled “Systems, Methods, and Apparatus for Providing Information to a Mobile Device”; U.S. patent application Ser. No. ______ (Attorney Docket No. 34250-1327) filed Mar. 2, 2009 and entitled “Systems, Methods, and Apparatus for Receiving Promotion Information by a Mobile Device”; and U.S. patent application Ser. No. _______ (Attorney Docket No. 34250-1328) filed Mar. 2, 2009 and entitled “Systems, Methods, and Devices for Processing Feedback Information Received from Mobile Devices Responding to Tone Transmissions.” Each of these applications is incorporated by reference herein in its entirety.

### FIELD OF THE INVENTION

Embodiments of the invention relate generally to marketing, and more particularly, to systems, methods, and apparatus for communicating information to a mobile device in a broadcast signal.

### BACKGROUND OF THE INVENTION

Conventionally, a wide variety of marketing and advertising information is communicated to consumers through broadcast signals, such as, television signals and radio signals. Conventionally, broadcast signals include audio and/or video messages that are output by to a consumer via a device that receives the broadcast signal such as a television or radio. These conventional signals, however, are typically transitory signals that only provide information to a consumer for a limited period of time. For example, once a television or radio commercial has been output in a broadcast signal, the marketing and advertising information is no longer available for review by a consumer. Additionally, these conventional broadcast signals do not facilitate any interaction with the consumer, and therefore, are unable to communicate any additional information to the consumer, such as special offers, rebates, coupons, surveys, etc.

With the widespread use of mobile devices, such as cellular phones or smart phones, new opportunities for communicating information to a consumer are presented. Various methods for providing marketing and advertising information to consumers have been developed. For example, text message advertisements may be sent to a mobile device. Conventional mobile marketing techniques, such as text message advertisements, may have costs associated with them that a user of a mobile device is unwilling to pay. Accordingly, these conventional mobile marketing techniques may not reach a segment of a target audience. Additionally, conventional mobile marketing techniques often require that an identifier of the mobile device, such as a telephone number, be known prior to communicating information to a mobile device.

Therefore, a need exists in the art for systems, methods, and apparatus for marketing by communicating information to a mobile device. A further need exists in the art for systems, methods, and apparatus for communicating information to a mobile device in a broadcast signal.

### BRIEF DESCRIPTION OF THE INVENTION

Some or all of the above needs and/or problems may be addressed by certain embodiments of the invention. Embodiments of the invention may include systems, methods, and apparatus for facilitating the communication of information to a mobile device in a broadcast signal. According to one embodiment of the invention, a method for communicating information to a mobile device may be provided. A tone may be inserted into a broadcast signal, the tone including at least one location identifier for information associated with the tone. The broadcast signal may be output for communication to a tone transmission device that is operable to communicate the tone to a mobile device. Once received by the mobile device, the at least one location identifier may facilitate the receipt, by the mobile device from an information source, of the information associated with the tone.

In accordance with another embodiment of the invention, there is provided a broadcast signal provider that facilitates the communication of information to a mobile device in a broadcast signal. The broadcast signal provider may include at least one output device and at least one processor. The at least one output device may be operable to transmit a broadcast signal for receipt by a tone transmission device. The at least one processor may be operable to insert a tone into the broadcast signal and to direct the at least one output device to transmit the broadcast signal for receipt by the tone transmission device. The tone may include at least one location identifier for information associated with the tone the transmission of the tone by the at least one output device. The tone transmission device may be operable to receive the broadcast signal with the tone and output the tone to a mobile device. Once received by the mobile device, the at least one location identifier may facilitate the receipt, by the mobile device from an information source, of the information associated with the tone.

According to yet another embodiment of the invention, a method for communicating information to a mobile device may be provided. Tone data that facilitates the generation of a tone may be received from a tone data source. A tone may be generated utilizing at least a portion of the received tone date, the tone including at least one location identifier for information associated with the tone. The tone may be inserted into a broadcast signal, and the broadcast signal may be output for communication to a tone transmission device that is operable to communicate the tone to a mobile device. Once received by the mobile device, the at least one location identifier may facilitate the receipt, by the mobile device from an information source, of the information associated with the tone. Additional systems, methods, apparatus, features, and aspects are realized through the techniques of various embodiments of the invention. Other embodiments and aspects of the invention are described in detail herein and are considered a part of the claimed invention. Other advantages and features can be understood with reference to the description and to the drawings.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram of one example system that may facilitate the communication of information to a mobile device, according to an illustrative embodiment of the invention.

FIG. 2 is a schematic diagram of another example system that may facilitate the communication of information to a mobile device, according to an illustrative embodiment of the invention.

FIG. 3 is a diagram of one example data flow of transmitting a tone and retrieving information associated with the tone, according to an illustrative embodiment of the invention.

FIGS. 4A and 4B are flow charts of one example method of communicating information to a mobile device through one or more tones, according to an illustrative embodiment of the invention.

FIG. 5 is a schematic diagram of yet another example system that may facilitate the communication of information to a mobile device, according to an illustrative embodiment of the invention.

FIG. 6 is a schematic diagram of a system that may facilitate the communication of information from a tone transmission device to a mobile device, according to an illustrative embodiment of the invention.

FIG. 7 is a diagram of an example data flow of transmitting a tone included in a broadcast signal and retrieving information associated with the tone, according to an illustrative embodiment of the invention.

FIGS. 8A and 8B are flow charts of one example method of communicating information to a mobile device through one or more tones included in a broadcast signal, according to an illustrative embodiment of the invention.

FIG. 9 is a block diagram of data that may be included in an example tone, according to an illustrative embodiment of the invention.

FIG. 10 is a flow chart of one example method for incorporating one or more tones into a broadcast signal by a broadcast entity, according to an illustrative embodiment of the invention.

FIG. 11 is a flow chart of one example method for incorporating one or more tones into a broadcast signal by an intermediary provider, according to an illustrative embodiment of the invention.

### DETAILED DESCRIPTION OF EMBODIMENTS OF THE INVENTION

In accordance with embodiments of the invention, systems and methods for providing marketing information to mobile device operators are provided. The widespread use of mobile devices, such as cellular phones or smart, phones, provides a new, very effective channel to reach potential customers to transmit information, such as marketing information like promotions, offers, coupons, discounts, and the like. Moreover, mobile devices provide a relatively simple and convenient means to request additional information and feedback from potential customers, as well as automatically monitor downstream uses tied to the marketing information transmitted to the mobile devices.

Example embodiments of the invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As used herein, the term “tone” may refer to a tone carrying information that may be communicated or transmitted to a mobile device by a tone transmission device. A wide variety of methods and/or techniques may be utilized to facilitate the communication of a tone from a tone transmission device to a mobile device. In certain embodiments of the invention, a tone may be output by one or more suitable output devices associated with the tone transmission device, for example, one or more speakers, and the tone may be received by one or more suitable input devices associated with the mobile device, for example, a microphone. A tone may be a wave, such as an elastic wave, a primary wave or P-wave, that is propagated between the tone transmission device and the mobile device. In certain embodiments of the invention, a tone may be a vibration wave that is propagated though a solid, liquid, or gas. For example, in various embodiments of the invention, a tone may be a sound wave that is emitted or otherwise output by the tone transmission device for reception by a mobile device. Tones in accordance with embodiments of the invention may have a wide variety of different frequencies and/or amplitudes as desired. For example, in some embodiments, a tone may be a sound wave that is within a range that may be detected by the human ear, for example, a sound wave with a frequency between approximately 20 hertz and approximately 20 kilohertz. In such an example embodiment of the invention, it may be desirable to have the tone be produced at a frequency range that is not detectable by the naked ear for at least a significant portion of the human population (e.g., a frequency range of 17 kilohertz-20 kilohertz). In other embodiments, a tone may be a sound wave that is outside the normal range that may be detected by the human ear, for example, a sound wave with a frequency above approximately 21 kilohertz. In these embodiments, a tone may be transmitted to a mobile device without being aurally detected by a user of the mobile device. Once received, the tone may be processed by the mobile device to extract the information included in the tone.

As used herein, the term “tone transmission device” may be any device, system, apparatus, or combination thereof that facilitates the communication of a tone to a mobile device. A tone transmission device may facilitate mobile marketing by communicating tones to a mobile device that are associated with various marketing information. Additionally, for purposes of this disclosure, the terms “tone transmission device” and “tone transmission system” may be used interchangeably. Examples of tone transmission devices include, but are not limited to, devices that are situated within a poster, billboard, etc., devices that are situated within a retail location (e.g., devices situated on the shelves of a grocery store), mobile devices, radios, televisions, speaker systems, public broadcast systems, public announcement system, point of sale terminals, computers, projectors, etc. Some example tone transmission devices and tone transmission systems are discussed in greater detail below.

As used herein, the term “mobile device” may refer to any mobile device that is operable to receive a tone from a tone transmission device. Mobile devices may be devices that are carried by a target user and information, such as marketing information, may be communicated to the user via the mobile devices. Examples of mobile devices include, but are not limited to, cellular phones, iPhones, smart phones, personal digital assistants (PDA's), pagers, digital audio players, handheld portable computing devices, digital tablets, laptop computers, etc. Additionally, for purposes of this disclosure, the terms “mobile device,” “mobile communications device,” “mobile phone,” “cellular phone,” and “cell phone” may be used interchangeably.

In accordance with example embodiments of the invention, systems, methods and apparatus for communicating information, such as marketing information, to a mobile device may be provided. A tone may be communicated from a tone transmission device to a mobile device. The tone may include various forms of data including, for example, at least one location identifier for identifying information that is associated with the tone. The mobile device may receive the tone from the tone transmission device and process the received tone to extract the at least one location identifier. The mobile device may then access one or more information sources utilizing the at least one location identifier in order to request additional information associated with the tone. The one or more information sources may communicate the additional information to the mobile device or to the operator by other means in response to the received request. In this regard, a mobile device may receive a tone from a tone transmission device that facilitates the access and/or receipt of additional information, such as marketing information, from one or more information sources.

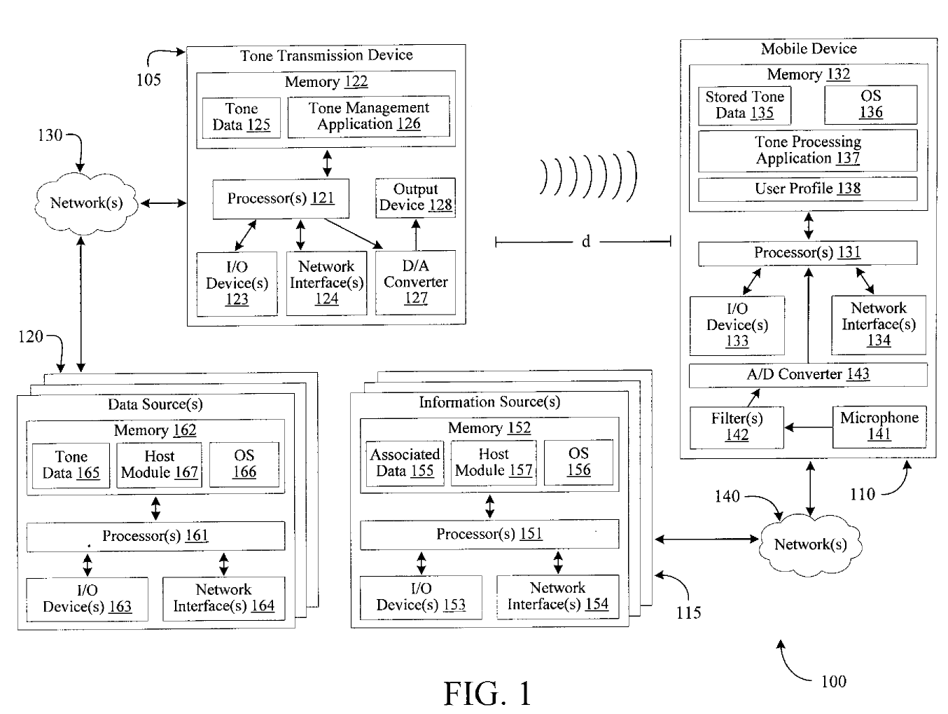

A wide variety of different systems may be utilized as desired in various embodiments of the invention to communicate information to a mobile device. A few example system are discussed below with reference to FIGS. 1-7.

FIG. 1 is a schematic diagram of one example system 100 that may facilitate the communication of information to a mobile device 110, according to an illustrative embodiment of the invention. The system 100 may be utilized to facilitate the communication of a wide variety of different information to a mobile device 110 through the use of communicating one or more tones to the mobile device 110. The system 100 may include a tone transmission device 105, a mobile device 110, and one or more information sources 115.

The tone transmission device 105 may be any suitable or appropriate device or system that facilitates the communication of a tone to a mobile device 110. In this regard, the tone transmission device 105 may facilitate mobile marketing. The tone transmission device 105 may be situated or placed in a wide variety of different locations or environments as desired in various embodiments of the invention. For example, the tone transmission device 105 may be incorporated into or situated proximate to a poster, billboard, sign, or other advertisement. The tone output by the tone transmission device 105 may be associated with a product or service that is referenced by the poster, billboard, sign, or other advertisement. As another example, the tone transmission device 105 may be situated at a merchant location, such as, a retail establishment. The tone transmission device 105 may be incorporated into or situated proximate to one or more products at the merchant location. For example, the tone transmission device 105 may be located on a shelf at the merchant location next to a product associated with a tone that is output by the tone transmission device 105 or the transmission device 105 may be located next to or incorporated into a cashier's station or kiosk inside the merchant location. As another example, the tone transmission device 105 may be a speaker system, public announcement system, or public broadcasting system that is situated within a merchant location, a sporting venue, or some other location. As yet another example, the tone transmission device 105 may be a mobile device that is operable to communicate a tone to another mobile device 110. As another example, the tone transmission device 105 may be a portable audio device (e.g., iPod, portable radio, etc.), a radio, a television, or other device that is capable of outputting a tone.

In certain embodiments of the invention, the size and/or dimensions of the tone transmission device 105 may be based at least in part on the application of the tone transmission device 105. For example, if the tone transmission device 105 is incorporated into a poster, the tone transmission device 105 may have relatively small dimensions that facilitate its incorporation into the poster. As another example, a tone transmission device 105 that is situated on or near a shelf at a merchant location may have relatively small dimensions. For example, the tone transmission device 105 may have a size that is smaller than or approximately equal to that of a conventional coupon holder. Additionally, the tone transmission device 105 may utilize a wide variety of different power sources as desired in various embodiments of the invention, for example, battery power, a direct current power source, an alternating current power source, or a network provided power source (e.g., power provided via a telephone line).

The tone transmission device 105 may be a processor driven device that facilitates the outputting and communication of a tone that may be received by a mobile device 110. For example, the tone transmission device 105 may include any number of special purpose computers or other particular machines, application specific circuits, microcontrollers, personal computers, minicomputers, and the like. In certain embodiments, the operations of the tone transmission device 105 may be controlled by computer-executed or computer-implemented instructions that are executed by one or more processors associated with the tone transmission device 105. The instructions may be embodied in one or more software components as desired in various embodiments of the invention. The execution of the instructions may form a special purpose computer or other particular machine that is operable to communicate a tone to a mobile device 110. The one or more processors that control the operations of the tone transmission device 105 may be incorporated into the tone transmission device 105 and/or in communication with the tone transmission device 105 via one or more suitable networks. In certain embodiments of the invention, the operations and/or control of the tone transmission device 105 may be distributed amongst several processing components.

The tone transmission device 105 may include one or more processors 121, one or more memory devices 122, one or more input/output (“I/O”) interface(s) 123, and one or more network interface(s) 124. The one or more memory devices 122 may be any suitable memory devices, for example, caches, read only memory devices, random access memory devices, magnetic storage devices, etc. The one or more memory devices 122 may store data, executable instructions, and/or various program modules utilized by the tone transmission device 105, for example, tone data 125 and/or a tone management application 126. The tone data 125 may include stored data associated with a tone that is output by the tone transmission device. For example, the tone data may include stored digital data associated with a tone, such as, a Waveform audio format (WAV) file, MPEG-1 Audio Layer 3 (MP3) file, Moving Picture Experts Group (MPEG) file, Audio Interchange File Format (AIFF) file, Advanced Audio Coding (AAC) file, Apple Lossless file, or other digital media file format. As another example, the tone data may include stored analog data associated with a tone, for example, magnetically stored analog data. Additionally, in certain embodiments of the invention, data associated with a tone may be received by the tone transmission device 105 and output by the tone transmission device 105 without being stored in one or more memory devices 122. Thus, in some embodiments of the invention the tone transmission device 105 does not include the one or more memory devices 122.

In certain embodiments of the invention, the tone transmission device 105 may include a tone management application 126. The tone management application 126 may include computer-executable instructions that facilitate the management of one or more tones by the tone transmission device 105. For example, the tone management application 126 may facilitate and/or control the receipt of tone data or other information associated with a tone, the generation of tone data, the storage of tone data, the accessing of stored tone data, the conversion of tone data into a form that may be output by the tone transmission device 105, and/or the output of a tone by the tone transmission device 105. In certain embodiments, the conversion of tone data into a form that may be output by the tone transmission device 105 may transform digital tone data into analog data that may be output by one or more suitable output devices, for example, one or more speakers. In certain embodiments of the invention, the tone management application 126 may also facilitate and/or control network communication between the tone transmission device 105 and one or more external devices, such as, one or more data sources 120. Although the tone management application 126 is illustrated as a single software component, the tone management application 126 may include any number of software components, modules, and/or applications as desired in various embodiments of the invention.

The one or more I/O interfaces 123 may facilitate communication between the tone transmission device 105 and one or more input/output devices, for example, a universal serial bus port, a serial port, a disk drive, a CD-ROM drive, infrared receiver, and/or one or more user interface devices, such as, a display, keyboard, keypad, mouse, control panel, touch screen display, remote control, microphone, etc. that facilitate user interaction with the tone transmission device 105. The one or more I/O interfaces may be utilized to receive or collect tone data from a wide variety of input devices. For example, tone data may be received from a portable memory device (e.g., thumb drive, portable hard drive, etc.) via the one or more I/O interfaces. Following receipt of the tone data via the one or more I/O interfaces, the received tone data may be processed by the tone management application 126 and stored in a memory device 122 associated with the tone transmission device 105. Additionally, in certain embodiments, the one or more I/O interfaces may be utilized to receive user input from a user of the tone transmission device 105, for example, a programmer of the tone transmission device 105. In this regard, one or more user preferences associated with the operation of the tone transmission device 105 may be received and processed. In certain embodiments of the invention, user input may be received by the tone transmission device 105 indicating a desire to have a tone output by the tone transmission device 105. For example, a user may press a button or activate a sensor associated with a tone transmission device 105, thereby causing the tone transmission device to output a tone.

The one or more network interfaces 124 may facilitate connection of the tone transmission device 105 to one or more suitable networks 130, for example, a local area network, a wide area network, the Internet, a telephone network, a broadcast network, a cellular network, a Bluetooth enabled network, a Wi-Fi network, a radio frequency network, any wired network, any wireless network, etc. In this regard, the tone transmission device 105 may receive tone data and/or user input from one or more external devices, network components, and/or systems via the one or more networks 130. For example, the tone transmission device 105 may receive tone data from one or more data sources 120 via the one or more networks 130. As one example, if the tone transmission device 105 is located at a merchant location, then the tone transmission device 105 may receive tone data from one or more data sources 120 located at the merchant location via a local area network. As another example, if the tone transmission device 105 is a television, then the tone transmission device 105 may receive tone data in association with a television signal, transmission, or broadcast received via a suitable television network (e.g., broadcast, cable, satellite, IP television, Internet, etc.). As yet another example, if the tone transmission device 105 is a radio, then the tone transmission device 105 may receive tone data in association with a radio signal, transmission, or broadcast via a suitable radio network (e.g., broadcast, satellite, Internet, etc.). As yet another example, if the tone transmission device 105 is a mobile device, then the tone transmission device 105 may receive tone data via communication over a cellular network or via an Internet connection.

According to an aspect of the invention, the tone transmission device 105 may output a tone for receipt by a mobile device 110. The tone transmission device 105 may output the tone via one or more suitable output devices 128, for example, one or more speakers. In certain embodiments of the invention, the tone management application 126 may direct and/or control the access of stored tone data 125 and the processing of the accessed tone data 125 to derive the tone that is output by the one or more output devices 128. For example, digital tone data 125 may be accessed from memory 122 and processed through a digital-to-analog converter 127 to derive the tone that is output by the one or more output devices 128. In this regard, the stored tone data 125 may be transformed into a tone that may be output by the tone transmission device 105 for receipt by a mobile device. In other embodiments of the invention, the tone transmission device 105 may receive tone data in a broadcast stream, such as a radio or television broadcast stream, and the tone transmission device may output the tone data as a tone in the audio output of the tone transmission device 105. For example, a television broadcast signal may include embedded tone information that is output by one or more speakers of a television as part of the audio output of the received television broadcast signal.

Embodiments of the invention may include tone transmission devices with more or less than the components illustrated for the tone transmission device 105 illustrated in FIG. 1. The description of the tone transmission device 105 of FIG. 1 is provided by way of example only and is not intended to be limiting.

With continued reference to FIG. 1, the mobile device 110 may be any suitable or appropriate device or system that facilitates the receipt of a tone from a tone transmission device 105 and the processing of the received tone. In this regard, the mobile device 110 may receive mobile marketing information through the receipt of one or more tones. The mobile device 110 may facilitate the receipt of tones from any number of tone transmission devices 105 in a wide variety of different locations or environments as desired in various embodiments of the invention. Once a tone is received by the mobile device 110, the tone may be processed by the mobile device 110 to extract information included in the tone, such as, one or more location identifiers that reference additional information associated with the tone. The extracted information may be utilized to access one or more information sources 115 to obtain at least a portion of the additional information associated with the tone.

Tones may be associated with a wide variety of different types of additional information that may be accessed by the mobile device 110 from one or more information sources 115. Examples of additional information that may be associated with tones include, but is not limited to, advertisements, coupons, special offers, and/or product or service information. Additionally, information extracted from a tone may facilitate the connection of the mobile device 110 to a website or other network site for a wide variety of purposes, including but not limited, the purchase of a product or service, the reservation or ordering of a product or service that is out of stock at a merchant location, the rating of a product, service, program, etc., or the ability to access information associated with related or competing products or services.

The mobile device 110 may be a processor driven device that facilitates the receipt of tones from tone transmission devices 105 and the processing of the received tones. For example, the mobile device 110 may include any number of special purpose computers or other particular machines, application specific circuits, microcontrollers, and the like. In certain embodiments, at least a portion of the operations of the mobile device 110 may be controlled by computer-executed or computer-implemented instructions that are executed by one or more processors associated with the mobile device 110. The instructions may be embodied in one or more software components as desired in various embodiments of the invention. The execution of the instructions may form a special purpose computer or other particular machine that is operable to receive and process tones. Additionally, in certain embodiments of the invention, the operations and/or control of the mobile device 110 may be distributed amongst several processing components.

The mobile device 110 may include one or more processors 131, one or more memory devices 132, one or more input/output (“I/O”) interface(s) 133, and one or more network interface(s) 134. The one or more memory devices 132 may be any suitable memory devices, for example, caches, read only memory devices, random access memory devices, magnetic storage devices, etc. The one or more memory devices 132 may store data, executable instructions, and/or various program modules utilized by the mobile device 110, for example, stored tone data 135 that is received by the mobile device 110, an operating system 136, a tone processing application 137, and/or a user profile 138. The stored tone data 135 may include information associated with and/or extracted from one or more tones that are received by the mobile device 110. For example, the stored tone data 135 may include one or more location identifiers that are extracted from received tones. As another example, the stored tone data 135 may include additional information associated with tones that is received from one or more information sources 115.

In certain embodiments of the invention, the mobile device 110 may include one or more software modules, such as an operating system 136 and/or a tone processing application 137. The operating system 136 may control the general operation of the mobile device 110, for example, the completion of telephone calls, the maintenance of an address book, the accessing of the Internet via a mobile browser application, etc. The operating system 136 may also facilitate the execution of other software modules by the one or more processors 131, for example, the tone processing application 137. The tone processing application 137 may include computer-executable instructions that facilitate the receipt and processing of one or more tones by the mobile device 110. For example, the tone processing application 137 may facilitate and/or control the receipt of tones from one or more tone transmission devices 105, the processing of received tones to extract one or more location identifiers associated with the tones, the communication of requests for additional information associated with a tone from one or more information sources 115, the receipt of additional information from one or more information sources 115, the processing of received additional information, the storage of received additional information, and/or the subsequent access and/or processing of stored additional information. In certain embodiments of the invention, the tone processing application 137 may also facilitate and/or control network communication between the mobile device 110 and one or more external devices, such as, one or more information sources 115. Although the tone processing application 137 is illustrated as a single software component, the tone processing application 137 may include any number of software components, modules, and/or applications as desired in various embodiments of the invention.

The user profile 138 may include one or more preferences and/or other information associated with one or more users of the mobile device 110. In certain embodiments, the user profile 138 may include one or more user preferences associated with types of desired tones and/or additional information that may be received and processed by the mobile device 110. For example, the user profile 138 may include preferences indicating that certain tones and/or additional information should be or should not be received and/or processed by the mobile device 110. In this regard, tones and/or additional information may be filtered by the mobile device 110. A wide variety of different preferences and/or criteria may be utilized as desired in various embodiments, including but not limited to, merchant criteria, merchant class or merchant type criteria, broadcaster criteria, marketing source criteria, etc. As another example, the user profile 138 may include one or more preference associated with the manner in which tones and/or additional information should be processed by the mobile device 110.

The one or more I/O interfaces 133 may facilitate communication between the mobile device 110 and one or more input/output devices, for example, one or more user interface devices, such as, a display, keypad, control panel, touch screen display, remote control, microphone, etc. that facilitate user interaction with the mobile device 110. In this regard, one or more user preferences associated with the operation of the mobile device 110 may be received and processed.

The one or more network interfaces 134 may facilitate connection of the mobile device 110 to one or more suitable networks 140, for example, a cellular network, a local area network, a Bluetooth enabled network, a Wi-Fi network, a radio frequency network, a wide area network, the Internet, any wired network, any wireless network, etc. In this regard, the mobile device 110 may receive additional information or data associated with tones from one or more external devices, network components, and/or systems via the one or more networks 140. The mobile device 110 may then process the received additional information and communicate with the one or more external devices, network components, and/or systems via the one or more networks 140. For example, the mobile device 110 may receive a tone from a tone transmission device 105 and extract information included in the tone or embedded in the tone, such as one or more location identifiers included in the received tone. The mobile device 110 may utilize the one or more extracted location identifiers to access one or more information sources 115 via a cellular network or mobile Internet browser and receive additional information associated with the tone. The mobile device 110 may utilize a wide variety of different techniques, methods, and/or systems to communicate with the one or more information sources 115. For example, a mobile Internet browser or other specific purpose or dedicated application may facilitate communication between the mobile device 110 and the one or more information sources 115. As another example, short message service (SMS) communications may be utilized to facilitate communication between the mobile device 110 and the one or more information sources 115.

According to an aspect of the invention, the mobile device 110 may receive and process one or more tones from any number of tone transmission devices 105. A tone may be output by a tone transmission device 105 and the mobile device 110 may identify and receive the output tone within a predetermined distance or range “d” from the tone transmission device 105. A tone transmission device 105 may have a wide variety of different ranges as desired in various embodiments of the invention, for example, a range of approximately three feet. In certain embodiments of the invention, the tone processing application 137 of the mobile device 110 may control the receipt of tones by the mobile device 110. For example, a setting or option associated with the tone processing application 137 may control the receipt of tones by the mobile device 110. When a user indicates that the setting or option should be set to allow tones to be received, the receipt of tones may be facilitated by the mobile device 110. However, when a user indicates that the setting or option should be set to disallow the receipt of tones, then the mobile device 110 will not process any tones output by a tone transmission device 105. In some embodiments, tones may be received and processed when a user of the mobile device opens, executes, or leaves on the tone processing application 137. In other embodiments, tones may be received and processed only when a user selects an option within the tone processing application 137 indicating that tones should be received.

The mobile device 110 may include one or more input devices that facilitate the receipt of tones. For example, a microphone 141 associated with the mobile device 110 may be utilized to receive tones that have been output by one or more speakers associated with a tone transmission device 105. After being received by the microphone 141, a tone may be passed through one or more filters, for example, one or more band pass filters that facilitate the isolation of the tone from other transmissions received by the microphone 141. The filtered tone may then be passed through one or more analog-to-digital converters 143 prior to being communicated to the one or more processors 131. In this regard, an analog tone may be transformed into digital information that may be processed by the tone processing application 137. The tone processing application may 137 process the digital information associated with the tone, and the tone processing application 137 may extract one or more location identifiers and/or other data associated with the tone. In certain embodiments of the invention, the tone processing application 137 may further filter the received digital information with one or more digital filters or software filters.

Once the one or more location identifiers have been extracted by the tone processing application 137, the tone processing application 137 may utilize the one or more location identifiers to receive additional information associated with the tone, for example, marketing information associated with the tone. The one or more location identifiers may facilitate the identification of one or more information sources 115 from which the additional information associated with the tone may be received. The tone processing application 137 may direct the communication of a request for the additional information to at least one information source 115 via a suitable network 140. The request may include at least one location identifier and/or an identifier of the mobile device 110, for example, a telephone number associated with the mobile device 110, a universal integrated circuit card (UICC) identifier, a unique device identifier (UDID), a subscriber identity module (SIM) card identifier, an international mobile subscriber identity (IMSI) number associated with the mobile device 110, or any other identifier that facilitates communication with an information source (e.g., a First Data Mobile Gateway identifier). Responsive to the request, the mobile device 110 may receive the requested additional information associated with the tone via the network 140. The tone processing application 137 may process at least a portion of the received additional information. Additionally, the tone processing application 137 may direct the storage of the one or more location identifiers and/or the received additional information in the memory 132 of the mobile device 110. As desired, at least a portion of the received additional information may be presented or output to a user of the mobile device 110 via one or more suitable output devices associated with the mobile device 110, for example, a display, speaker, headset, or an output device external to the mobile device 110.

Additional information associated with a tone may be utilized by a mobile device 110 for a wide variety of different purposes as desired in various embodiments of the invention. For example, additional information may include advertisement, marketing, or other information about a product, service, radio program, television program, etc., and at least a portion of the additional information may be formatted for and displayed to a user of the mobile device 110 via a suitable output device associated with the mobile device 110 (e.g., an LCD display). As another example, additional information may facilitate the display of selection or rating information on an output device associated with the mobile device 110. User input associated with rating products, services, a television program, or other content may be received and processed. As yet another example, additional information may include special offer or coupon information about a product or service. In some embodiments, the additional information may facilitate the display of information that allows a user of the mobile device to order, purchase, or reserve the product or service. In other embodiments, the additional information may be stored by the mobile device 110 and utilized in a subsequent purchase of a product or service. For example, the additional information may include a coupon for a product, and the coupon may be accessed from memory by the mobile device 110 at a point of sale terminal. The coupon may be displayed on a display of the mobile device, scanned from the display at the point of sale terminal, communicated from the mobile device 110 to the point of sale terminal via a suitable network connection, or communicated to an intermediary device that interacts with the point of sale terminal, such as, a contactless transaction device associated with the mobile device 110. In some embodiments, the coupon may include a promotional code that may be displayed to a user and/or communicated to a point of sale terminal.

Embodiments of the invention may include mobile devices 110 with more or less than the components illustrated for the mobile device 110 illustrated in FIG. 1. The description of the mobile device 110 of FIG. 1 is provided by way of example only and is not intended to be limiting.

With continued reference to FIG. 1, the system 100 may include any number of information sources 115 that are operable to provide additional information associated with tones to a mobile device. The additional information may be communicated to a mobile device 110 by an information source 115 in response to a request for the additional information, as discussed in greater detail above. In certain embodiments of the invention, a mobile device 110 may communicate requests directly to any number of information sources 115. In other embodiments, the mobile device 110 may communicate requests to a single information source or a central information source. The central information source may communicate with other information sources as desired in various embodiments of the invention and collect additional information that is communicated to the mobile device 110. Additionally or alternatively, the central information source may establish direct communication between the mobile device 110 and another information source, for example, via handing off a network session between the mobile device 110 and the central information source to another information source.

An information source 115 may be a processor driven device or network entity that facilitates the receipt of a request for additional information or data associated with a tone, the accessing of the additional information, and the communication of the additional information to another component of the system 100 in response to the received request for the additional information. For example, the additional information may be communicated to the mobile device 110 or to another information source 115 in response to a request for the additional information. The information source 115 may include any number of processors and/or processing components as desired in various embodiments of the invention. For example, the information source 115 may include any number of special purpose computers or other particular machines, application specific circuits, microcontrollers, personal computers, servers, and the like. In certain embodiments, at least a portion of the operations of the information source 115 may be controlled by computer-executed or computer-implemented instructions that are executed by one or more processors associated with the information source 115. The instructions may be embodied in one or more software components as desired in various embodiments of the invention. The execution of the instructions may form a special purpose computer or other particular machine that is operable to receive and process requests for additional information associated with tones. Additionally, in certain embodiments of the invention, the operations and/or control of the information source 115 may be distributed amongst several processing components.

The information source 115 may include one or more processors 151, one or more memory devices 152, one or more input/output (“I/O”) interface(s) 153, and one or more network interface(s) 154. The one or more memory devices 152 may be any suitable memory devices, for example, caches, read only memory devices, random access memory devices, magnetic storage devices, databases, etc. The one or more memory devices 152 may store data, executable instructions, and/or various program modules utilized by the information source 115, for example, additional information 155 associated with tones, an operating system 156, and/or a host module 157. The stored additional data 155 may include any information associated with a tone that may be received by a mobile device 110. For example, the stored additional data 155 may include marketing information associated with a tone.

In certain embodiments of the invention, the information source 115 may include one or more software modules, such as an operating system 156 and/or a host module 157. The operating system 156 may control the general operation of the information source 115 and may facilitate the execution of other software modules by the one or more processors 151, for example, the execution of the host module 157. The host module 157 may include computer-executable instructions that facilitate the receipt and processing of one or more requests for additional information associated with tones. For example, the host module 157 may facilitate and/or control the receipt, from one or more mobile devices 110 and/or other information sources, of requests for additional information associated with tones, the processing of the received requests to access the additional information, and the communication of the additional information to the requesting entity. Additionally, the host module 157 may facilitate and/or control network communication between the information source 115 and one or more external devices, such as, a mobile device 110 and/or other information sources. Although the host module 157 is illustrated as a single software component, the host module 157 may include any number of software components, modules, and/or applications as desired in various embodiments of the invention.

A request for additional information associated with a tone may include one or more location identifiers that have been extracted from the tone by the mobile device 110. Additionally, the request may include an identifier of the mobile device 110. The host module 157 may receive the request and process the request to extract the one or more location identifiers and/or the identifier of the mobile device 110. In other words, the received request may be transformed by the host module 157 into data that is representative of the one or more location identifiers and/or the identifier of the mobile device 110. The one or more location identifiers may be utilized to access additional information associated with at tone. For example, a location identifier may be utilized to search for additional information associated with a tone that is stored in a memory 152 of the information source. In certain embodiments, a location identifier may function as a pointer to stored additional information. As another example, a location identifier may be utilized in the generation of a request for additional information that is communicated to another information source. One or more location identifiers may reference other information sources and/or memory locations associated with the other information sources. The host module 157 may generate a request for additional information and communicate the request to the other information sources. The request may be processed by a host module of the other information sources and the requested additional information may be communicated to the requesting host module 157. Once the additional information has been obtained by the host module 157, at least a portion of the additional information may be communicated by the host module 157 to the mobile device 110 via one or more suitable networks 140.

The one or more I/O interfaces 153 may facilitate communication between the information source 115 and one or more input/output devices, for example, a keyboard, mouse, display, keypad, control panel, touch screen display, remote control, microphone, disc drive, CD-ROM drive, infrared receiver, a device connected via a universal serial bus (USB) port, a device connected via a serial port, etc. In this regard, input associated with the operation of the information source 115 be received and information processed by the information source 115 may be output.

The one or more network interfaces 154 may facilitate connection of the information source 115 to one or more suitable networks 140, for example, a cellular network, a local area network, a wide area network, the Internet, a Bluetooth enabled network, a Wi-Fi network, a radio frequency network, any wired network, any wireless network, etc. In this regard, the information source 115 may receive requests for additional information and may communicate additional information associated with tones to a requesting mobile device 110. Additionally, the information source 115 may communicate with other information sources as desired. The information source 115 may utilize a wide variety of different techniques, methods, and/or systems to communicate with a mobile device 110 and/or with other information sources. For example, a web server or other specific purpose or dedicated application may facilitate communication between the information source 115 and the mobile device 110. As another example, short message service (SMS) communications may be utilized to facilitate communication between the information source 115 and the mobile device 110.

Embodiments of the invention may include information sources 115 with more or less than the components illustrated for the information source 115 illustrated in FIG. 1. The description of the information source 115 of FIG. 1 is provided by way of example only and is not intended to be limiting.

In certain embodiments of the invention, at least a portion of the additional information associated with a tone may be stored by a mobile device 110 prior to the receipt of the tone by the mobile device 110. The tone processing application 137 of the mobile device may process the received tone to extract one or more location identifiers, and the one or more extracted location identifiers may be utilized to access at least a portion of the prestored additional information. As one example, additional information associated with items or artifacts in a museum may be prestored in the memory 132 of the mobile device 110 prior to a user of the mobile device 110 visiting a museum or a portion of the museum (e.g., a particular gallery, room, floor, etc.). The additional information may be received by the mobile device 110 utilizing a wide variety of different techniques or methods as desired. For example, the additional information may be received from an information source in the museum via one or more suitable networks, for example, a Bluetooth enabled network, a Wi-Fi network, an RFID network, cellular network, Internet connection, etc. As another example, the additional information may be received from a personal computer or portable memory storage device. As yet another example, the additional information may be downloaded to the mobile device via a mobile (Wireless Access Protocol or Internet) browser application. The receipt, storage, subsequent access, and/or subsequent processing of the additional information may be managed by the tone processing application 137 in certain embodiments of invention. As the user tours through the museum and views items or artifacts, one or more tones associated with the viewed items or artifacts may be received by the mobile device 110. A received tone may be processed in order to extract at least one location identifier, and the location identifier may be utilized to access a portion of the prestored information associated with the items or artifacts. The additional information may be output to the user via one or more suitable output devices, such as, a display, speaker, and/or a headset. In this regard, a user may be provided with additional information about items and artifacts as the user tours through the museum.

With continued reference to FIG. 1, the system 100 may include any number of data sources 120 that are operable to communicate or otherwise provide tone data to the tone transmission device 105. In certain embodiments of the invention, a data source 120 may communicate tone data to the tone transmission device 105 via one or more suitable networks 130. Tone data may be communicated to a tone transmission device 105 in response to the receipt, from the tone transmission device 105, of a request for the tone data. Alternatively, a data source 120 may push or otherwise communicate tone data to the transmission device 105 without the tone data being requested. For example, in a merchant location, a data source 120 may push tone data associated with a product to a tone transmission device 105 situated proximate to the product. As another example, a data source 120 may include a broadcasting entity that incorporates tone data into broadcast information, such as a radio or television broadcast, that is communicated to a radio or television that functions as a tone transmission device.

A data source 120 may be a processor driven device or network entity that facilitates the communication tone data to another component of the system 100, for example, a tone transmission device 105 or another data source 105. The data source 120 may include any number of processors and/or processing components as desired in various embodiments of the invention. For example, the data source 120 may include any number of special purpose computers or other particular machines, application specific circuits, microcontrollers, personal computers, servers, and the like. In certain embodiments, at least a portion of the operations of the data source 120 may be controlled by computer-executed or computer-implemented instructions that are executed by one or more processors associated with the data source 120. The instructions may be embodied in one or more software components as desired in various embodiments of the invention. The execution of the instructions may form a special purpose computer or other particular machine that is operable to communicate tone data. Additionally, in certain embodiments of the invention, the operations and/or control of the data source 120 may be distributed amongst several processing components.

The data source 120 may include one or more processors 161, one or more memory devices 162, one or more input/output (“I/O”) interface(s) 163, and one or more network interface(s) 164. The one or more memory devices 162 may be any suitable memory devices, for example, caches, read only memory devices, random access memory devices, magnetic storage devices, databases, etc. The one or more memory devices 162 may store data, executable instructions, and/or various program modules utilized by the data source 120, for example, tone data 165 associated with tones, an operating system 166, and/or a host module 167. The stored tone data 165 may include stored data associated with a tone that is communicated to a tone transmission device 105 for output by the tone transmission device 105. For example, the stored tone data 165 may include stored digital data associated with a tone, such as, a WAV file, MP3 file, MPEG file, AIFF file, AAC file, Apple Lossless file, or other digital media file format.

In certain embodiments of the invention, the data source 120 may include one or more software modules, such as an operating system 166 and/or a host module 167. The operating system 166 may control the general operation of the data source 120 and may facilitate the execution of other software modules by the one or more processors 161, for example, the execution of the host module 167. The host module 167 may include computer-executable instructions that facilitate the communication of tone data 165 to a tone transmission device 105. For example, the host module 167 may facilitate and/or control the receipt, from a tone transmission device 105, of a request for tone data 165, the processing of the received requests to access the tone data 165, and/or the communication of tone data 165 to the tone transmission device 105. As another example, the host module 167 may facilitate the establishment of a network session or other communication with the tone transmission device 105, and the host module 167 may direct the communication or transmission of tone data 165 to the tone transmission device 105. The host module 167 may also facilitate and/or control network communication between the data source 120 and one or more other data sources. Although the host module 167 is illustrated as a single software component, the host module 167 may include any number of software components, modules, and/or applications as desired in various embodiments of the invention.

The one or more I/O interfaces 163 may facilitate communication between the data source 120 and one or more input/output devices, for example, a keyboard, mouse, display, keypad, control panel, touch screen display, remote control, microphone, disc drive, CD-ROM drive, infrared receiver, a device connected via a universal serial bus (USB) port, a device connected via a serial port, etc. In this regard, input associated with the operation of the data source 120 may be received and information processed by the data source 120 may be output.

The one or more network interfaces 164 may facilitate connection of the data source 120 to one or more suitable networks 130, for example, a local area, network, a wide area network, the Internet, a cellular network, a Bluetooth enabled network, a Wi-Fi network, a radio frequency network, any wired network, any wireless network, etc. In this regard, the data source 120 may communicate tone data 125 to a tone transmission device 105. Additionally, the data source 120 may communicate with other data sources as desired in various embodiments of the invention. For example, a first data source 120 may receive tone data 125 from a second data source 120, and the first data source 120 may communicate the received tone data 125 to the tone transmission device 105.

Embodiments of the invention may include data sources 120 with more or less than the components illustrated for the data source 120 illustrated in FIG. 1. The description of the data source 120 of FIG. 1 is provided by way of example only and is not intended to be limiting. Additionally, in certain embodiments, a data source 120 and an information source 115 may be the same device or system.

Although FIG. 1 has been described as having specific functions performed by specific components of the system 100, various functions and/or operations of embodiments of the invention may be performed by any suitable component of the system 100. In certain embodiments, various functions and/or operations that are described as being performed by multiple components may be performed by a single component of the system 100. For example, a tone transmission device 105 may also function as an information source 115. Additionally, various operations may be completed in a distributed manner by multiple components of the system 100.

Additionally, certain components of the system 100 are described as having any number of processors or processing components. Operations may be completed by the one or more processors as desired in various embodiments of the invention. A different processor may be provided to complete or facilitate each operation of a system component, or alternatively, multiple operations may be completed or facilitated by a single processor. For example, a first processor of the mobile device 110 may facilitate the processing of a received tone to extract one or more location identifiers associated with the tone; a second processor may facilitate the storage of the extracted one or more location identifiers; a third processor may facilitate the communication of a request for additional information associated with the tone to one or more information sources; and a fourth processor may facilitate the receipt of the requested additional information from the one or more information sources. As desired, two or more of the first, second, third, and fourth processors may be the same processor. Although the example above relates to the operations of the mobile device 110, the operations of other components of the system 100 may be completed and/or facilitated in a similar manner.

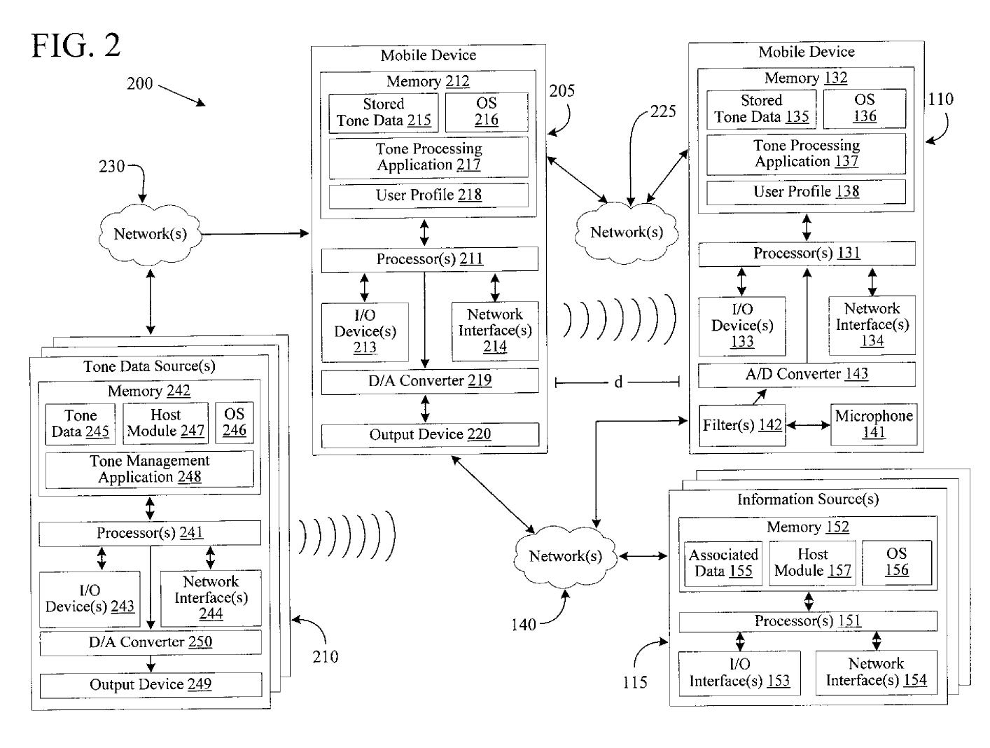

FIG. 2 is a schematic diagram of another example system 200 that may facilitate the communication of information to a mobile device, according to an illustrative embodiment of the invention. The system 200 of FIG. 2 may be similar to the system 100 described above with reference to FIG. 1. However, in the system 200 of FIG. 2, a tone may be communicated by a first mobile device 205 or transmitting mobile device to a second mobile device 110 or receiving mobile device. In this regard, the first mobile device 205 may act as a tone transmission device similar to the tone transmission 105 discussed above with reference to FIG. 1. The system 200 may include a first or transmitting mobile device 205, a second mobile device 110, and one or more information sources 115. The functionality of the second or receiving mobile device 110 and the one or more information sources 115 may be similar to that described above with reference to FIG. 1. Additionally, the interactions between the receiving mobile 110 and the one or more information sources 115 via any number of suitable networks 140 may be similar to that described above with reference to FIG. 1

The transmitting mobile device 205 may be any suitable or appropriate mobile device that facilitates the communication of a tone to a receiving mobile device 110. Although the first mobile device 205 is described as the device that communicates a tone to a second mobile device 110, it will be appreciated that the second mobile device 110 may communicate one or more tones to the first mobile device 205 as desired in various embodiments of the invention. In this regard, information may be communicated between the two mobile devices 205, 110 via the use of one or more tones and the processing of the tones by the mobile devices 205, 110.

The transmitting mobile device 205 may be a processor driven device that facilitates the generation, receipt, and/or storage of one or more tones and the communication or transmission of a tone to a receiving mobile device 110. In various example embodiments, the transmitting mobile device 205 may include any number of special purpose computers or other particular machines, application specific circuits, microcontrollers, and the like. In certain embodiments, the operations of the transmitting mobile device 205 may be controlled by computer-executed or computer-implemented instructions that are executed by one or more processors associated with the transmitting mobile device 205. The instructions may be embodied in one or more software components as desired in various embodiments of the invention. The execution of the instructions may form a special purpose computer or other particular machine that is operable to receive, generate, store, access, and/or communicate a tone. Additionally, in certain embodiments of the invention, the operations and/or control of the transmitting mobile device 205 may be distributed amongst several processing components. For purposes of describing the components and operation of the transmitting mobile device 205, the transmitting mobile device 205 is simply referred to as a mobile device 205.

The mobile device 205 may include one or more processors 211, one or more memory devices 212, one or more input/output (“I/O”) interface(s) 213, and one or more network interface(s) 214. The one or more memory devices 212 may be any suitable memory devices, for example, caches, read only memory devices, random access memory devices, magnetic storage devices, etc. The one or more memory devices 212 may store data, executable instructions, and/or various program modules utilized by the mobile device 205, for example, tone data 215, an operating system 216, a tone processing application 217, and/or a user profile 218. The tone data 215 may include stored data associated with one or more tones that have been generated by the mobile 205, that have been received by the mobile device 205, and/or that may be output by the mobile device 205. For example, the tone data 215 may include stored digital data associated with a tone, such as, a WAV file, MP3 file, MPEG file, AIFF file, AAC file, Apple Lossless file, or other digital media file format. As another example, the tone data 215 may include information that has been extracted from one or more tones received by the mobile device 205, such as one or more location identifiers that have been extracted from received tones. As yet another example, the tone data 215 may include additional information associated with one or more tones that has been received from the mobile device 205 from one or more information sources, such as, information sources 115.

In certain embodiments of the invention, the mobile device 205 may include one or more software modules, such as an operating system 216 and/or a tone processing application 217. The operating system 216 may control the general operation of the mobile device 205, for example, the completion of telephone calls, the maintenance of an address book, the accessing of the Internet via a mobile browser application, etc. The operating system 216 may also facilitate the execution of other software modules by the one or more processors 211, for example, the tone processing application 217. The tone processing application 217 may include computer-executable instructions that facilitate the management and/or processing of one or more tones by the mobile device 205. For example, the tone processing application 217 may facilitate and/or control the receipt of tone data or other information associated with a tone, the receipt of tones from one or more other tone transmission devices, such as tone transmission device 105 shown in FIG. 1, the generation of tone data, the storage of tone data, the accessing of stored tone data, the conversion of tone data into a form that may be output by the mobile device 205, and/or the output of a tone or tone data by the mobile device 205. The tone processing application 217 may also facilitate the receipt of additional information associated with tones, the generation of additional information associated with tones, the storage of additional information associated with tones, and/or the communication of the additional information associated with tones. In certain embodiments of the invention, the tone processing application 217 may also facilitate and/or control network communication between the mobile device 205 and one or more external devices, such as, one or more tone data sources 210 or another mobile device 110. Although the tone processing application 217 is illustrated as a single software component, the tone processing application 217 may include any number of software components, modules, and/or applications as desired in various embodiments of the invention.

The user profile 218 may include one or more preferences and/or other information associated with one or more users of the mobile device 205. The user profile 218 may be similar to the user profile 138 described above with reference to FIG. 1.

The one or more I/O interfaces 213 may facilitate communication between the mobile device 205 and one or more input/output devices, for example, one or more user interface devices, such as, a display, keypad, control panel, touch screen display, remote control, microphone, etc. that facilitate user interaction with the mobile device 205. In this regard, one or more user preferences associated with the operation of the mobile device 205 may be received and processed.

The one or more network interfaces 214 may facilitate connection of the mobile device 205 to one or more suitable networks, such as networks 225, 230 and/or 140. Each of the networks may include any number of suitable networks as desired, for example, a local area network, a wide area network, the Internet, a telephone network, a broadcast network, a cellular network, a Bluetooth enabled network or network connection, a Wi-Fi enabled network or network connection, a radio frequency network or network connection, any wired network, any wireless network, etc. Additionally, although separate networks are illustrated as connecting various components of the system 200, in certain embodiments of the invention, one or more of the illustrated networks may be the same network. Various communications may be facilitated as desired by the mobile device 205 via the various networks 225, 230, 140. For example, the mobile device 205 may communicate with any number of tone data sources 210 via network(s) 230. In tins regard, the mobile device 205 may receive tone data from one or more tone data sources 210. As another example, the mobile device 205 may communicate with any number of information sources 115 via network(s) 140. In this regard, the mobile device 205 may request and/or receive additional information associated with tones that have been received by the mobile device 205. Additionally, the mobile device 205 may upload or otherwise communicate additional data associated with one or more tones to an information source 115 for subsequent access by another mobile device, such as mobile device 110. For example, if a tone is generated by a mobile device, then additional information associated with the tone may be communicated to an information source 115. If the mobile device 205 later communicates the generated tone to another mobile device 110, then the receiving mobile device 110 may process the received tone and then communicate with the information source 115 to receive the additional information associated with the tone.

As yet another example of network communication by the mobile device 205, the mobile device 205 may communicate with other mobile devices, such as mobile device 110 via network(s) 225. In this regard, the mobile device 205 may communicate tone information and/or other information to another mobile device 110 via suitable network communications, for example, SMS messaging or other communications over a cellular network.

In certain embodiments of the invention, tones may be generated by the mobile device 205. The tone processing application 217 may include computer executable instructions that facilitates the generation of a tone. The generation of a tone may include the generation of digital data in an audio format, such as, a WAV file, MP3 file, MPEG file, AIFF file, AAC file, Apple Lossless file, or other digital media file format. Information that is embedded into a tone, for example, one or more location identifiers that facilitate the access of additional information associated with a tone, may also be generated by the tone processing application 217. The one or more location identifiers may be embedded into a digital audio file by the tone processing application 217. In addition to generating one or more tones, the mobile device 205 may receive tones from one or more other devices as desired, for example, a tone generation device, a computer, etc.

Additional information associated with a generated tone or other tone may be generated by the mobile device 205 and/or received by the mobile device 205 from another system component. The additional information may be uploaded or otherwise communicated to an information source 115. The additional information may be stored in any suitable memory devices associated with one or more information sources 115, for example, memory 152. In some embodiments of the invention, the additional information may be stored in a general memory that may later be searched to access the stored additional information. In other embodiments, the additional information may be stored in a dedicated memory or memory partition that is allocated to or otherwise reserved for the mobile device 205 and/or a user of the mobile device 205. The dedicated memory may be referenced by one or more location identifiers associated with a tone, and the dedicated memory may be subsequently accessed based at least in part on the one or more location identifiers. Additionally and/or alternatively, the dedicated memory may be accessed utilizing an identifier of the mobile device 205 or user of the mobile device 205 that directs the upload of the additional information to an information source 115.

In certain embodiments of the invention, one or more location identifiers may be generated subsequent to the uploading of additional information to one or more information sources 115. For example, a communication may be received from an information source 115 indicating one or more memory locations at which the additional information is stored and the one or more location identifiers may be generated by the tone processing application 217 based at least in part on the received memory location information. In other embodiments, one or more location identifiers may be generated by an information source 115 and communicated to the mobile device 205. Identifiers of a mobile device 205 or user of a mobile device 205 may be generated in a similar manner and embedded in a tone that is output by a mobile device 205.

According to an aspect of the invention, the mobile device 205 may output a tone for receipt by another mobile device 110. The mobile device 205 may output the tone via one or more suitable output devices 220, for example, one or more speakers. In certain embodiments of the invention, the tone management application 217 may direct and/or control the access of stored tone data 215 and the processing of the accessed tone data 215 to derive the tone that is output by the one or more output devices 220. For example, digital tone data 215 may be accessed from memory 212 and processed through a digital-to-analog converter 219 to derive the tone that is output by the one or more output devices 220. In this regard, the stored tone data 215 may be transformed into a tone that may be output by the mobile device 205 for receipt by another mobile device 110. The receiving mobile device 110 may identify and receive the tone if it is within a range “d” of the transmitting mobile device 205.

The communication of tones and/or tone information between two mobile devices, such as mobile devices 205 and 110 may be utilized for a wide variety of different purposes. For example, a tone associated with a coupon or other marketing information may be received by a first mobile device 205 and communicated to a second mobile device 110. As another example, tones may be communicated between two mobile devices 110, 205 for social networking and/or other networking purposes. One or more tones may be generated or received by a first mobile device 205 and then communicated to a second mobile device 110 for social networking purposes. For example, information associated with a tone may identify a sender of the tone and/or dedicated memory for the sender, such as, dedicated memory stored at an information source or a social networking website associated with the sender (e.g., a Facebook website, MySpace website, etc.). The second mobile device 110 may process received tones and communicate one or more tones back to the first mobile device 205 as desired. In this regard, social networking communications may be facilitated between the two mobile devices 205, 110. Additionally, in certain embodiments, the mobile devices 205, 110 may include a social networking module that processes tones associated with social networking. The social networking module may be part of a tone processing application 137, 217 or a separate application. Additionally, as desired in certain embodiments, each mobile device 205, 110 and/or each user of a mobile device may have a dedicated memory at one or more information sources 115 that stores information associated with the mobile device and/or the user. At least a portion of this stored information may be accessed using location identifiers that are embedded in one or more tones that are communicated between the mobile devices 205, 110.

In addition to the communication of tones between two mobile devices 205, 110, the two mobile device 205, 110 may communicate with one another via one or more suitable networks 225, for example, a cellular network, local area network, wide area network, the Internet, a Bluetooth enabled network, a Wi-Fi network, a radio frequency network, etc.

Embodiments of the invention may include mobile devices 205 with more or less than the components illustrated for the mobile device 205 illustrated in FIG. 2. The description of the mobile device 205 of FIG. 2 is provided by way of example only and is not intended to be limiting.

With continued reference to FIG. 2, the system 200 may include any number of data sources 210 or tone data sources. Each data, source 210 may be operable to communicate or otherwise provide data to a mobile device 205 that may be utilized in the communication of one or more tones between the mobile device 205 and a second mobile device 110. The data communicated from a data source 210 may include one or more tones and/or data that is utilized to generate tones by the mobile device 205. For purposes of describing the data sources 210, the data may be referred to as tone data.

In certain embodiments of the invention, a data source 210 may communicate tone data to a mobile device 205 via one or more suitable networks 230, for example, a cellular network, a local area network, a wide area network, the Internet, a Bluetooth enabled network, a Wi-Fi network, a radio frequency network, any wired network, any wireless network, etc. Additionally, as desired in various embodiments, a data source 210 may communicate tone data to a mobile device 205 via one or more tones that are output by the data source 210 and received by the mobile device 205. Tone data, additional information associated with tones, and information utilized to generate tones may be received by the mobile device 205 from any number of data sources 210 and/or information sources 115.

In certain embodiments, tone data and/or tones may be communicated from a data source 210 to a mobile device 205 in response to the receipt, from the mobile device 205, of a request for the tone data and/or tones. Alternatively, a data source 210 may push or otherwise communicate tone data and/or tones to the mobile device 205 without the tone data and/or tones being requested. A wide variety of different devices and/or systems may be utilized as a data source 210 as desired in various embodiments of the invention. Examples of data sources include a personal computer, a mobile device, a data source similar to the data source 120 described above with reference to FIG. 1, a tone transmission device similar to the tone transmission device 105 described above with reference to FIG. 1, etc.

A data source 210 may be a processor driven device or network entity that facilitates the communication of tone data and/or tones to the mobile device 205. The data source 210 may include any number of processors and/or processing components as desired in various embodiments of the invention. For example, the data source 210 may include any number of special purpose computers or other particular machines, application specific circuits, microcontrollers, personal computers, servers, and the like. In certain embodiments, at least a portion of the operations of the data source 210 may be controlled by computer-executed or computer-implemented instructions that are executed by one or more processors associated with the data source 210. The instructions may be embodied in one or more software components as desired in various embodiments of the invention. The execution of the instructions may form a special purpose computer or other particular machine that is operable to communicate tone data and/or tones. Additionally, in certain embodiments of the invention, the operations and/or control of the data source 210 may be distributed amongst several processing components.

A data source 210 may include one or more processors 241, one or more memory devices 242, one or more input/output (“I/O”) interface(s) 243, and one or more network interface(s) 244. The one or more memory devices 242 may be any suitable memory devices, for example, caches, read only memory devices, random access memory devices, magnetic storage devices, databases, etc. The one or more memory devices 242 may store data, executable instructions, and/or various program modules utilized by the data source 210, for example, tone data 245 associated with tones, an operating system 246, a host module 247, and/or a tone management application 248. The stored tone data 245 may include stored data that may be utilized by the mobile device 205 to generate or create a tone, stored data associated with a tone that is communicated to a mobile device 205 for output by the mobile device 205, and/or additional information associated with a tone. For example, the stored tone data 245 may include data that may be utilized by a mobile device 205 to generate a digital file that may be output by the mobile device 205 as a tone, for example, a WAV file, MP3 file, MPEG file, AIFF file, AAC file, Apple Lossless file, etc. As another example, the stored tone data 245 may include stored digital data associated with a tone, such as, a WAV file, MP3 file, MPEG file, AIFF file, AAC file, Apple Lossless file, or other digital media file format. For purposes of further describing the data source 210, the term “tone data” 245 is utilized to include tones and/or data associated with tones.

In certain embodiments of the invention, the data source 210 may include one or more software modules, such as an operating system 246, a host module 247, and/or a tone management application 248. The operating system 246 may control the general operation of the data source 210 and may facilitate the execution of other software modules by the one or more processors 241, for example, the execution of the host module 247 and/or the tone management application 248. The host module 247 may include computer-executable instructions that facilitate the communication of tone data 245 to a mobile device, such as mobile device 205. For example, the host module 247 may facilitate and/or control the receipt, from a mobile device 205, of a request for tone data 245, the processing of the received requests to access the tone data 245, and/or the communication of tone data 245 to the mobile device 205. As another example, the host module 247 may facilitate the establishment of a network session or other communication with the mobile device 205, and the host module 247 may direct the communication or transmission of tone data 245 to the mobile device 205. The host module 247 may also facilitate and/or control network communication between the data source 210 and one or more other data sources. Although the host module 247 is illustrated as a single software component, the host module 247 may include any number of software components, modules, and/or applications as desired in various embodiments of the invention.

In certain embodiments of the invention, the data source 210 may include a tone management application 248. The tone management application 248 may include computer-executable instructions that facilitate the management of one or more tones and/or information associated with the tones by the data source 210. For example, the tone management application 248 may facilitate and/or control the receipt of tone data or other information associated with a tone, the generation of tone data, the storage of tone data, the accessing of stored tone data, the conversion of tone data into a form that may be output by the data source 210, and/or the output of a tone by the data source 210. In certain embodiments of the invention, the tone management application 248 may also facilitate and/or control network communication between the data source 210 and one or more external devices, such as, the mobile device 205. Although the tone management application 248 is illustrated as a single software component, the tone management application 248 may include any number of software components, modules, and/or applications as desired in various embodiments of the invention.

The one or more I/O interfaces 243 may facilitate communication between the data source 210 and one or more input/output devices, for example, a keyboard, mouse, display, keypad, control panel, touch screen display, remote control, microphone, disc drive, CD-ROM drive, infrared receiver, a device connected via a universal serial bus (USB) port, a device connected via a serial port, etc. In this regard, input associated with the operation of the data source 210 be received and information processed by the data source 210 may be output.

The one or more network interfaces 244 may facilitate connection of the data source 210 to one or more suitable networks 230, for example, a local area network, a wide area network, the Internet, a cellular network, a Bluetooth enabled network, a Wi-Fi network, a radio frequency network, any wired network, any wireless network, etc. In this regard, the data source 210 may communicate tone data 245 to a mobile device 205. Additionally, the data source 210 may communicate with other data sources and/or mobile devices as desired in various embodiments of the invention. For example, a first data source 210 may receive tone data 245 from a second data source, and the first data source 210 may communicate the received tone data 245 to a mobile device 205.

In certain embodiments of the invention, a data source 210 may be operable to output a tone for receipt by the first mobile device 205. The first mobile device 205 may then communicate the tone to a second mobile device 110. The data source 210 may output the tone via one or more suitable output devices 249, for example, one or more speakers. In certain embodiments of the invention, the tone management application 248 may direct and/or control the access of stored tone data 245 and the processing of the accessed tone data 245 to derive the tone that is output by the one or more output devices 249. For example, digital tone data 245 may be accessed from memory 242 and processed through a digital-to-analog converter 250 to derive the tone that is output by the one or more output devices 249. In this regard, the stored tone data 245 may be transformed into a tone that may be output by the data source 210 for receipt by a mobile device 205. In other embodiments of the invention, the data source 210 may receive tone data in a broadcast stream, such as a radio or television broadcast stream, and the data source may output the tone data as a tone in the audio output of the data source 210. For example, a television broadcast signal may include embedded tone information that is output by one or more speakers of a television as part of the audio output of the received television broadcast signal.

Embodiments of the invention may include data sources 210 with more or less than the components illustrated for the data source 210 illustrated in FIG. 2. The description of the data source 210 of FIG. 2 is provided by way of example only and is not intended to be limiting.

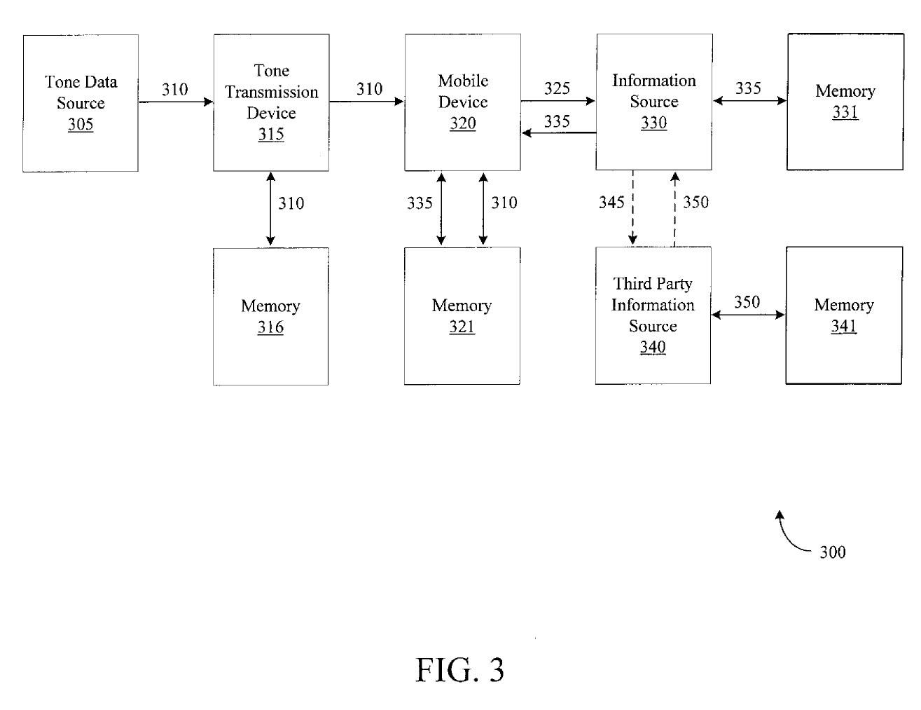

FIG. 3 is a diagram of one example data flow 300 of transmitting a tone and retrieving information associated with the tone, according to an illustrative embodiment of the invention. The data flow 300 may be applicable to a wide variety of systems utilized to communicate tones to a mobile device, including but not limited to, the system 100 illustrated in FIG. 1 and the system 200 illustrated in FIG. 2.

With reference to FIG. 3, a tone data source 305 may communicate a tone 310 to a tone transmission device 315. The tone transmission device 315 may include any device that is capable of communicating or outputting the tone 310 to the mobile device 320. Examples of suitable tone transmission devices 315 include, but are not limited to, an advertising device that is configured to output a tone, a device that outputs a broadcast signal (e.g., a television, radio, etc.), a mobile device, a point of sale terminal, a personal computer, etc. The tone data source 305 may include any device or number of devices that are capable of communicating a tone 310 or information associated with a tone to the tone transmission device 315. Examples of tone data sources include, but are not limited to, personal computers, servers, network devices, network systems, mobile devices, tone transmission devices, etc. In various embodiments of the invention, the tone data source 305 may communicate a tone 310 or information associated with a tone to the tone transmission device 315 in response to a request that is received from the tone transmission device 315. In other embodiments of the invention, the tone data source 305 may proactively push the tone 310 or information associated with a tone to the tone transmission device via a suitable network. In still other embodiments of the invention, the tone data source 305 may output one or more tones via one or more suitable output devices, such as one or more speakers, and the one or more tones, may be received and processed by the tone transmission device 315. The one or more tones output by the tone data source 305 may include the tone 310 and/or information associated with the tone 310.

Although FIG. 3 illustrates the tone data source 305 as communicating a tone 310 to the tone transmission device 315, in various embodiments of the invention, the tone data source 305 may communicate information associated with the tone 310 to the tone transmission device 315, and the tone transmission device 315 may utilize a portion or all of the received information to generate the tone 310 that is to be output by the tone transmission device 315.

Additionally, in various embodiments of the invention, the tone 310 and/or information associated with the tone 310 may be stored by the tone transmission device 315 in one or more suitable memory devices 316, for example, one or more caches, read only memory devices, random access memory devices, magnetic storage devices, etc. In certain embodiments, the tone 310 or information associated with the tone 310 may be accessed from the one or more memory devices 316 and output by the tone transmission device 315. Additionally, in certain embodiments, information associated with the tone 310 may be utilized by the tone transmission device 315 to generate the tone 310 to be output.

In certain embodiments of the invention, the tone 310 may be communicated from the tone transmission device 315 to the mobile device 320 by being output from one or more suitable output devices associated with the tone transmission device 315, for example, one or more speakers. In certain embodiments, the tone 310 may be output by the tone transmission device 315 in response to a request that is received from the mobile device 320. In other embodiments, the tone 310 may be proactively output by the tone transmission device 315 for reception by the mobile device 320. For example, the tone 310 may be periodically output by the tone transmission device 315 at regular time intervals, such as, every 5 seconds, every 10 seconds, every 15 seconds, etc. As another example, the tone 310 may be continuously output by the tone transmission device 315 in a loop. In other embodiments of the invention, the tone 310 may be output by the tone transmission device 315 based upon the receipt of user input to output the tone 310. For example, if the tone transmission device 315 is a mobile device, a user of the mobile device may utilize one or more user interfaces and/or user input devices (e.g., touchpad, touch screen, microphone, etc.) to direct the tone 310 to be output by the mobile device.

After being output by the tone transmission device 315, the tone 310 may be received by the mobile device 320. According to an aspect of the invention, the tone 310 may be received by a microphone associated with the mobile device 320. After being received by a microphone, the tone 310 may be processed through one or more filters (e.g., band pass filters) as desired and converted into digital data utilizing an analog-to-digital converter. The digital data from the tone 310 may be processed by one or more appropriate software modules and/or software applications associated with the mobile device 320, for example, a tone processing application as described above with reference to FIGS. 1 and 2. One or more location identifiers may be extracted from the digital data by the mobile device 320. Additionally, as desired in various embodiments of the invention, the received tone 310, digital data and/or the one or more extracted location identifiers may be stored in one or more suitable memory devices 321 associated with the mobile device 320, for example, one or more caches, read only memory devices, random access memory devices, etc.

The mobile device 320 may utilize the one or more extracted location identifiers to request additional information associated with the tone 310 from one or more information sources 330. The mobile device 320 may generate a request 325 for additional information associated with the tone 310, and the mobile device 320 may communicate the request 325 to one or more information sources 330. The request 325 may include one or more of the extracted one or more location identifiers and an identifier of the mobile device 320, for example, a universal integrated circuit card (UICC) identifier, a unique device identifier (UDID), a subscriber identity module (SIM) card identifier, an international mobile subscriber identify (IMSI) number associated with the mobile device 320, or any other identifier that facilitates communication with an information source (e.g., a First Data Mobile Gateway identifier). In certain embodiments, the mobile device 320 may communicate with a central information source 330 when requesting additional information associated with a tone 310. In certain other embodiments, one or more of the location identifiers may identify one or more information sources that the mobile device 320 will communicate with in order to request additional information associated with a tone 310. In other embodiments, the mobile device 320 may initially communicate with a central information source 330 and a communication session may be passed off by the central information source 330 to another information source. In yet other embodiments, the mobile device 320 may initially communicate with a central information source 330 and the central information source 330 may establish communication sessions between the mobile device 320 and one or more other information sources. FIG. 3 illustrates the mobile device 320 communicating with a single information source 330 to request additional information associated with a tone 310; however, the mobile device 320 may communicate with any number of information sources 330, 340 as desired in other embodiments of the invention.

The request 325 for additional information associated with a tone 310 may be communicated from a mobile device 320 to an information source 330 via one or more suitable networks, for example, a cellular network, a local area network, a wide area network, the Internet, a Bluetooth network or network connection, a Wi-Fi network or network connection, a radio frequency network or network connection, any wired network, any wireless network, etc. The request 325 may be received and processed by the information source 330. The information source 330 may utilize one or more of the location identifiers to access additional information 335 associated with the tone 310 from any number of suitable memory devices 331 associated with the information source, for example, caches, read only memory devices, random access memory devices, magnetic storage devices, databases, etc. As an example, if the tone 310 is associated with a product, the information source 330 may utilize one or more location identifiers extracted from the tone 310 to access advertising, marketing, promotional, discount, and/or rebate information associated with the product.

Additionally, in certain embodiments of the invention, the information source 330 may communicate a request 345 for additional information associated with the tone 310 to one or more third party information sources 340. The one or more third party information sources 340 may be identified by the information source 330 from one or more of the location identifiers extracted from the tone 310 by the mobile device 320. The request 345 that is communicated to the one or more third party information sources 340 may include one or more location identifiers extracted from the tone 310 and/or an identifier of the information source 340. Communication between the information source 330 and the one or more third party information sources 340 may be facilitated via one or more suitable networks, for example, a local area network, a wide area network, the Internet, a Bluetooth enabled network a Wi-Fi network, a radio frequency network, any wired network, any wireless network, etc.

A third party information source 340 may receive and process a request 345 for additional information from the information source 330. The third party information source 340 may utilize one or more of the location identifiers to access additional information 350 associated with the tone 310 from any number of suitable memory devices 341 associated with the third party information source 340, for example, caches, read only memory devices, random access memory devices, magnetic storage devices, databases, etc. The third party information source 340 may then communicate the accessed additional information 350 to the information source 330 via the one or more suitable networks in response to the request 345. The information source 330 may receive the additional information 350 from the third party information source 340. In some embodiments, additional information 350 may be received by the information source 330 from multiple third party information sources 340, and the information source 330 may combine the received additional information 350 to generate the additional information 335 that will be communicated to the mobile device 320. Additionally, as desired in various embodiments, additional information 350 received from third party information sources 340 may be combined with additional information accessed by the information source 330. When combining information received and/or accessed from various sources, the information source 330 may extract duplicate information and/or resolve conflicts between conflicting information as desired in various embodiments. In this regard, the additional information 335 to be communicated to the mobile device 320 may be formatted for communication to the mobile device 320.

Once the additional information 335 associated with the tone 310 has been accessed and/or received by the information source 330, the information source 330 may communicate the additional information 335 to the mobile device 320 in response to the request 325 for additional information that was received from the mobile device 320. In certain embodiments, the information source 330 may store various data associated with a request for additional information 335 that is received from the mobile device 320. For example, the information source 330 may store an indication that the mobile device 320 requested the additional information 335 and/or an indication that the additional information 335 was communicated to the mobile device 320. In this regard, tone activity for a user of the mobile device 320 may be tracked by the information source 330.

The mobile device 320 may receive the additional information 335 from the information source 330. As desired in various embodiments, the mobile device 320 may store a portion or all of the received additional information 335 in memory 321.

Additionally, as desired in various embodiments, the mobile device 320 may display at least a portion of the additional information to a user of the mobile device 320 via one or more suitable output devices, for example, a display. As an example, advertising information, promotions, special offers, and/or coupons for a product associated with the tone 310 may be displayed to the user. In certain embodiments, the mobile device 320 may utilize at least a portion of the additional information 335 to communicate with another entity. For example, the additional information 335 may include a link, such as a hyperlink, that facilitates the establishment of communication between the mobile device 320 and another entity, such as, an information source 330, 340, or another entity, system, or device associated with the tone 310. In this regard, the mobile device 310 may be utilized to access other information associated with the tone 310, for example, a web site that includes information associated with the tone 310. The mobile device 310 may also be utilized to communicate user preferences and/or other user input information associated with the tone 310 and/or the additional information 335. For example, a user may enter a rating for a product, radio show, television show, etc. that is associated with the tone 310, and the input rating information may be communicated to one or more other entities, such as, an information source 330, 340, a distributor of a product, a manufacturer of a product, a retailer of a product, a broadcaster of a show, etc.

Many variations may be made to the data flow 300 illustrated in FIG. 3 as desired in various embodiments of the invention. The data flow 300 is not intended to be limiting, but instead is provided by way of example only as an illustrative embodiment of the invention.

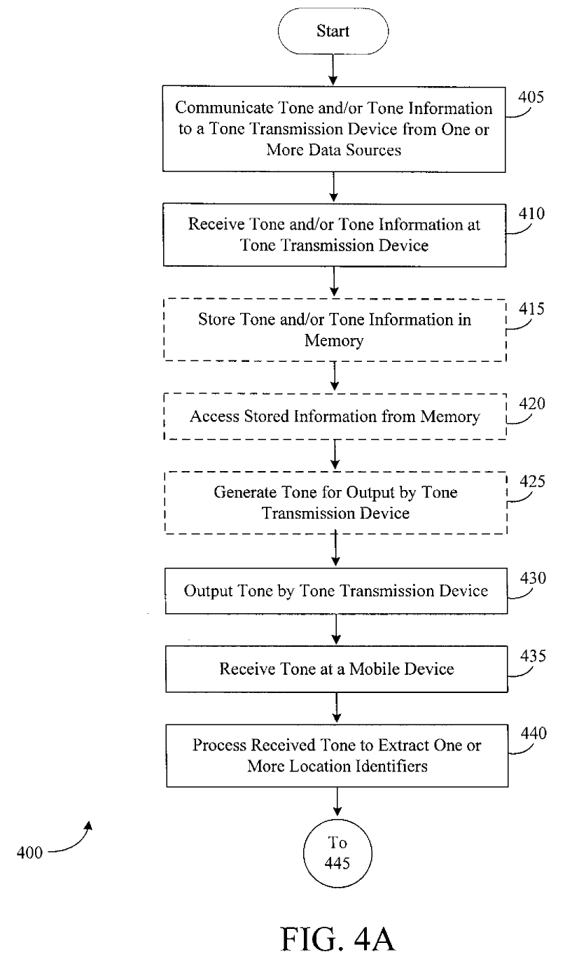

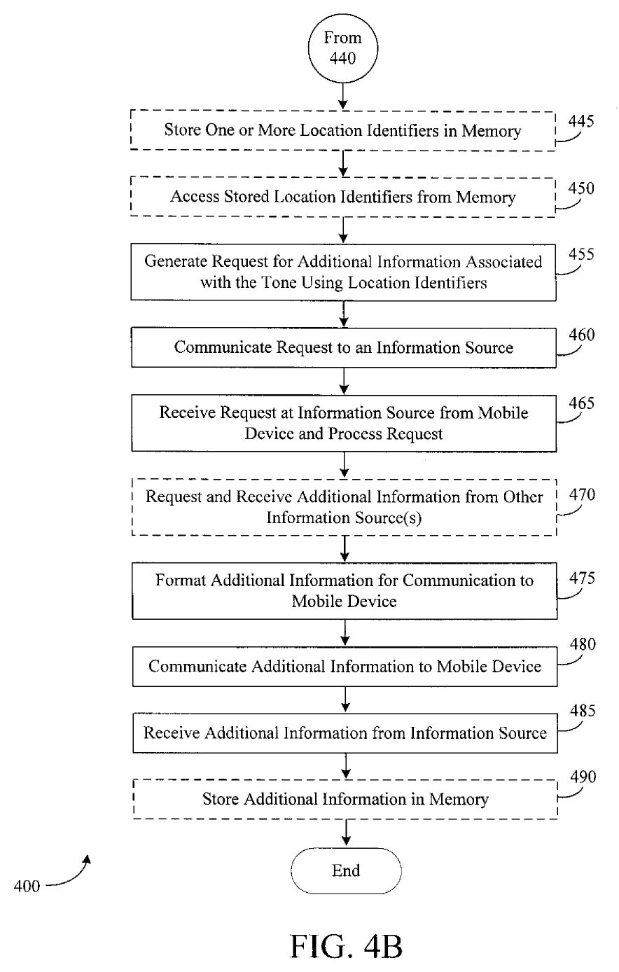

FIGS. 4A and 4B are flow charts of one example method 400 of communicating information to a mobile device through one or more tones, according to an illustrative embodiment of the invention. The method 400 may include various operations that are performed by a tone transmission device, a mobile device, and/or an information source as desired in various embodiments of the invention. Additionally, the method 400 may include communicating a tone to a mobile device and processing the received tone at the mobile device to facilitate requesting additional information associated with the tone.

The method 400 may begin at block 405. At block 405, one or more tones and/or tone information may be communicated to a tone transmission device, for example, the tone transmission device 315 illustrated in FIG. 3 from one or more data sources or tone data sources, for example, the one or more tone data sources 305 illustrated in FIG. 3. The one or more tones and/or tone information may be received by the tone transmission device 315 at block 410. The communication may be facilitated via one or more suitable networks and/or via the outputting of tones by a tone data source 305 that are received by the tone transmission device 315 as desired in various embodiments of the invention. If tones are output by a tone data source 305 and received by the tone transmission device 315, the tone transmission device 315 may process the received tones in order to digitally store the tones and/or to extract information from the tones that may be utilized to generate tones that are output by the tone transmission device 315.

At block 415, which may be optional in various embodiments of the invention, the tone transmission device 315 may store received tones and/or tone information in one or more suitable memory devices, for example, caches, read only memory devices, random access memory devices, magnetic storage devices, etc. Information or data stored by the tone transmission device 315 may include any data that is utilized to output a tone by the tone transmission device 315 and/or to generate a tone to be output.

At block 420, which may be optional in various embodiments of the invention, the tone transmission device 315 may access stored information associated with one or more tones to be output. In some embodiments, the tone transmission device 315 may access digital data that represents a tone to be output, such as, a WAV file, MP3 file, MPEG file, AIFF file, AAC file, Apple Lossless file, or other digital media file format. In other embodiments, the tone transmission device 315 may access information that is utilized to generate digital data that represents a tone, for example, to generate a WAV file, MP3 file, etc. In these embodiments, the tone transmission device may generate a tone for output at block 425.

At block 430, the tone transmission device 315 may output one or more tones. Any number of tones may be output by the tone transmission device 315 as desired in various embodiments of the invention. In certain embodiments, to output a tone, the tone transmission device 315 may pass digital data that represents a tone through one or more digital-to-analog converters, and the digital data may be transformed or converted into analog data for the tone. The analog data may then be output by one or more suitable output devices associated with the tone transmission device 315, for example, one or more speakers.

At block 435, one or more tones output by the tone transmission device 315 may be received at a mobile device, for example, mobile device 320 illustrated in FIG. 3. The one or more tones may be received by one or more suitable input devices associated with the mobile device 320, for example, a microphone associated with the mobile device 320. In certain embodiments, a tone may be picked up by a microphone if the mobile device 320 is within a certain range of the tone transmission device, for example, within approximately two to approximately six feet. After being picked up by a microphone or other input device, the tone may be passed through one or more filters, for example, one or more band pass filters, to filter out noise, and the tone may then be transformed or converted into a digital representation of the tone utilizing one or more analog-to-digital converters associated with the mobile device 320. As desired in various embodiments, further filtering may be conducted on the digital representation of the tone utilizing one or more digital and/or software filters. For purposes of completing the description of FIG. 4, the digital representation of a tone may be referred to as a tone.

At block 440, the received tone may be processed by the mobile device 320 in order to extract one or more location identifiers included in the received tone. The one or more location identifiers may identify one or more data sources and/or one or more memory locations at the one or more data sources at which additional information associated with the received tone is stored. A location identifier for a data source may be utilized to identify an information source, such as information source 330 or information source 340, that is contacted to obtain additional information associated with a tone. A location identifier for a memory location may be communicated to a data source and utilized by the data source to identify additional information associated with a tone that is stored at the data source. After the one or more location identifiers are extracted by the mobile device 320, the mobile device 320 may store the extracted one or more location identifiers in memory at block 445, which may be optional in certain embodiments of the invention. Additionally, at block 450, which may be optional in certain embodiments of the invention, the stored one or more location identifiers may be accessed from memory and utilized in the generation of a request for additional information associated with the tone.

At block 455, the mobile device 320 may generate a request for additional information associated with one or more received tones. As desired in various embodiments of the invention, a portion or all of the extracted location identifiers may be utilized in the generation of the request. For example, a location identifier for an information source 330, 340 may be utilized to identify an information source 330, 340 to which a request for additional information is communicated. In this regard, a generated request may be addressed to an identified information source 330, 340 that processes the request. Additionally, a portion or all of the extracted location identifiers may be included in a generated request. Location identifiers for memory location may facilitate the retrieval or access, by an information source 330, 340 of stored additional information associated with a tone. Location identifiers associated with identified information sources may facilitate a first information source 330 communicating with a second information source 340 to request additional information associated with a tone and/or to establish communication between the second information source 340 and the mobile device 320.

In addition to one or more location identifiers, a generated request for additional information may include an identifier of the mobile device 320, for example, a telephone number associated with the mobile device 320, a universal integrated circuit card (UICC) identifier, a unique device identifier (UDID), a subscriber identity module (SIM) card identifier, an international mobile subscriber identity (IMSI) number associated with the mobile device 320, or any other identifier that facilitates communication with an information source (e.g., a First Data Mobile Gateway identifier). In this regard, the mobile device 320 may be identified by an information source 330, 340 for responding to a generated request.

The mobile device 320 may communicate requests for additional information associated with a tone to a wide variety of different information sources as desired in various embodiments of the invention. Additionally, as desired in various embodiments of the invention, an information source may process a received request for additional information in a wide variety of different manners. A few non-limiting examples of the communication and processing of requests for additional information are set forth below.

As one example, in certain embodiments of the invention, a request may be generated by a mobile device 320 to be communicated to a central information source 330 that processes all requests for additional information for the mobile device 320. Examples of a central information source 330 or central service provider may include a mobile service provider system, or a system or entity associated with a tone processing application utilized by the mobile device 320. For example, First Data Corporation™ may provide a central information source 330 that receives and processes requests for additional information that are received from mobile devices. Examples of suitable platforms that may be utilized include, but are not limited to, the First Data Mobile Gateway Platform and the First Data Size Platform. In this situation, a tone received by the mobile device 320 may not include a location identifier for the central information source 330, as this information may be stored at the mobile device 320. Additionally, location identifiers for third party information sources, such as information source 340, may or may not be included in the generated request. In certain embodiments, a location identifier for a third party information source 340 may be included in a generated request to facilitate communication between the central information source 330 and the third party information source 340. In this regard, the central information source 330 may request and receive additional information from the third party information source 340, and the central information source 330 may communicate the additional information to the mobile device 320. Alternatively, the central information source 340 may facilitate the establishment of communication between the third party information source 340 and the mobile device 320, and the third party information source 340 may communicate additional information directly to the mobile device 320.

In embodiments where a location identifier for a third party information source 340 is not included in a request generated by a mobile device 320 and communicated to the central information source 330, the central information source 330 may still communicate with a third party information source 340 if desired. In some embodiments, the central information source 330 may have an identifier of the third party information source 340 stored in memory, and the identifier may be accessed when processing the request generated by the mobile device 320. For example, a location identifier of a memory location, or block of memory may be received in the request and the identifier for the third party information source 340 may be included in the referenced memory. In this regard, additional information associated with a tone can be obtained from a wide variety of sources while the amount of data that is stored in the tone is minimized.

As another example, in certain embodiments of the invention, one or more requests may be generated by a mobile device 320 to be communicated to any number of information sources. In this regard, the mobile device 320 may communicate directly with third party information sources 340 or other information sources rather than with a central information source 330. In these embodiments, the generated requests and the processing of the requests by an information source may be similar to that described above for the central information source 330.

With continued reference to FIG. 4, the mobile device 320 may communicate a generated request for additional information to an information source, such as information source 330, at block 460. The request may be communicated over a wide variety of different networks and/or utilizing a wide variety of different techniques as desired in various embodiments of the invention. Examples of suitable networks that may be utilized include, but are not limited to, a cellular network, a local area network, a wide area network, the Internet a Bluetooth enabled network, a Wi-Fi network, a radio frequency network, any wired network, any wireless network, etc. Examples of suitable programs, techniques, and/or methods for communicating a generated request to an information source 330 include, but are not limited to, communicating a request via a SMS message, communicating a request via a web she hosted by the information source 330 and accessed by a mobile Internet browser, etc.

The request for additional information may be received and processed by the information source 330 at block 465. During the processing of the request, the information source may access one or more suitable memory devices utilizing one or more location identifiers included in the received request. As explained in greater detail above, certain location identifiers may reference a specific memory location or a block of memory at which additional information associated with a tone is stored. These location identifiers may be utilized by the information source 330 to access the referenced memory and retrieve the additional information associated with the tone.

At block 470, which may be optional in certain embodiments of the invention, the information source 330 may communicate one or more requests for additional information associated with a tone to one or more additional information sources, for example, the one or more third party information sources 340 shown in FIG. 3, and additional information may be received by the information source 330 in response to the one or more requests. The information source 330 may generate a request to be sent to a third party information source 340 in a similar manner as that in which a request is generated by the mobile device 320. Additionally, a request may be processed by a third party information source 340 in a similar manner as that in which a request is processed by the information source 330. Communications between the information source 330 and the one or more third party information sources 340 may be facilitated via any number of suitable networks, for example, a cellular network, a local area network, a wide area network, the Internet, any wired network, any wireless network, etc. In this regard, additional information associated with a tone may be collected and combined at the information source 330 before being communicated to the mobile device 320. Although the example above discusses the collection of additional information at a single information source 330, other embodiments of the invention may include the direct communication of additional information to the mobile device 320 from any number of information sources 330.

At block 475, the information source 330 may format the additional information associated with a tone for communication to the mobile device 320. If additional information is received from multiple sources, then the additional information may be consolidated and any duplicate information may be identified and eliminated. Further, the additional information may be formatted into one or more suitable communication packets and/or communication streams for transmission to the mobile device 320.

The additional information may be communicated by the information source 330 to the mobile device 320 at block 480 and received by the mobile device at block 485. The communication may be facilitated via any number of suitable networks and/or utilizing any suitable method and/or technique, as discussed in greater detail above.

Once the additional information is received by the mobile device 320 at block 480, the mobile device 320 may process the received additional information in a wide variety of different manners as desired in various embodiments of the invention. For example, at least a portion of the additional information may be displayed to a user of the mobile device 320 via one or more suitable output devices, such as, a suitable display. In this regard, advertising information, special offers, rebates, coupons, and other types of information may be presented to the user. Additionally, at block 490, which may be optional in various embodiments of the invention, a portion or ail of the received additional information may be stored by the mobile device 320 in one or more suitable memory devices.

The method 400 may end following block 490.

The operations described and shown in the method 400 of FIGS. 4A and 4B may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 4A and 4B may be performed.

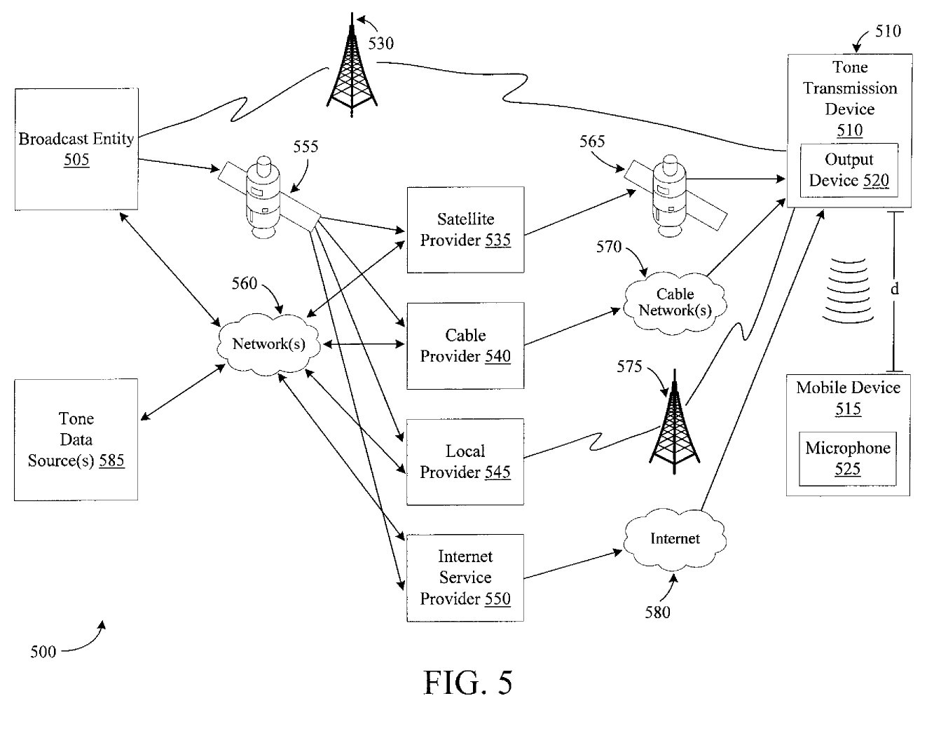

FIG. 5 is a schematic diagram of yet another example system 500 that may facilitate the communication of information to a mobile device 515, according to an illustrative embodiments of the invention. The system of FIG. 5 may facilitate the communication of one or more tones to a mobile device 515 via a broadcast signal, for example, a radio or television broadcast. The mobile device 515 may then be utilized to request and receive additional information associated with the one or more tones that are received via the broadcast signal. In this regard, a user of the mobile device 515 may receive additional information associated with a broadcast, for example, advertisement information, rebates, and or coupons associated with an advertised product or service, rating information associated with a television or radio show, rating information associated with a product or service, etc.

With reference to FIG. 5, the system 500 may include a broadcast entity 505, a tone transmission device 510, and a mobile device 515. The broadcast entity 505 may be operable to generate a broadcast signal or a broadcast stream that is communicated directly and/or indirectly to any number of tone transmission devices 510. Examples of broadcast companies include, but are not limited to, television networks, television broadcast companies, radio stations, etc. Examples of broadcast signals include, but are not limited to, television broadcast signals, radio broadcast signals, etc.

The tone transmission device 510 may be any suitable device that is operable to receive a broadcast signal and output at least a portion of the received broadcast signal to one or more users. Examples of tone transmission devices 510 include, but are not limited to, televisions, radios, television antennas, cable boxes, satellite television receivers, satellite radios, any combination of these devices (e.g., a television and a cable box), etc.

As desired in various embodiments of the invention, one or more tones may be included in a broadcast signal that is received by a tone transmission device 510. The tone transmission device 510 may receive the one or more tones in a broadcast signal and output the one or more received tones with the broadcast signal. The one or more received tones may be communicated by the tone transmission device 510 to a mobile device 515. For example, one or more suitable output devices 520, such as one or more speakers associated with the tone transmission device 510, may be utilized to output the one or more tones. The one or more tones may then be received by one or more input devices 525, such as a microphone, associated with the mobile device 515. In this regard, one or more tones included in a broadcast signal may be communicated to a mobile device 525, and the mobile device 525 may process the one or more received tones to extract one or more location identifiers that are utilized to gather additional information associated with the one or more tones.

In certain embodiments of the invention, a broadcast entity 505 may communicate a broadcast signal directly to a tone transmission device 510. For example, a broadcast entity 505 may utilize one or more transmission lowers 530 to transmit or otherwise communicate audio and/or video signals that may be directly received by the tone transmission device 510 and/or equipment associated with the tone transmission device 510, for example, an antenna associated with the tone transmission device 510.

In other embodiments of the invention, a broadcast entity 505 may communicate a broadcast signal to one or more intermediary systems and/or service providers 535, 540, 545, 550. The one or more intermediary systems and/or service providers 535, 540, 545, 550 may receive the broadcast signal from the broadcast entity 505 and communicate the broadcast signal to the tone transmission device 510. A wide variety of techniques and/or systems may be utilized as desired to communicate the broadcast signal from the broadcast entity 505 to an intermediary system or service provider 535, 540, 545, 550. For example, the broadcast entity 505 may communicate a broadcast signal to an intermediary system 535, 540, 545, 550 via one or more satellites 555 and/or satellite communications systems, such as, the EchoStar Technologies™ satellite communications system. As another example, the broadcast entity 505 may communicate a broadcast signal to an intermediary system 535, 540, 545, 550 via one or more suitable networks 560, such as, a fiber optic network, a cable network, an IP television network, the Internet, a wide area network, any suitable wired network, and/or any suitable wireless network. As yet another example, the broadcast entity 505 may utilize one or more transmission towers 530 to transmit or otherwise communicate the broadcast signal to an intermediary system 535, 540, 545, 550.

Any number of intermediary systems and/or service providers 535, 540, 545, 550 may be utilized as desired in various embodiments of the invention. An intermediary system 535, 540, 545, 550 may receive a broadcast signal from a broadcast entity 505 or from another intermediary system 535, 540, 545, 550 as desired in various embodiments. The intermediary system 535, 540, 545, 550 may then communicate the received broadcast signal to the tone transmission device 510 or to another intermediary system 535, 540, 545, 550. For purposes describing example intermediary systems 535, 540, 545, 550, the intermediary systems 535, 540, 545, 550 will be described as receiving a broadcast signal from a broadcast entity 505 and communicating the received broadcast signal to a tone transmission device 510. Examples of intermediary systems and/or service providers include, but are not limited to, a satellite provider 535, a cable provider 540, a local provider 545, an Internet Protocol (IP) television provider, and an internet service provider 550.

A satellite provider 535 may receive a broadcast signal from the broadcast entity 505 and transmit or otherwise communicate at least a portion of the broadcast signal to the tone transmission device 510 via one or more suitable satellites 565 and/or satellite communications systems, for example, a satellite television communications system or a satellite radio communications system. Similarly, a cable provider 540 may receive a broadcast signal from the broadcast entity 505 and transmit or otherwise communicate at least a portion of the broadcast signal to the tone transmission device 510 via one or more suitable cable networks 570. Similarly, a local provider 545 may receive a broadcast signal from the broadcast entity 505 and transmit or otherwise communicate at least a portion of the broadcast signal to the tone transmission device 510 via one or more suitable transmission towers 575. Similarly, an internet service provider (ISP) 550 or an IP television provider may receive a broadcast signal from the broadcast entity 505 and transmit or otherwise communicate at least a portion of the broadcast signal to the tone transmission device 510 via one or more suitable Internet connections, for example, a wide area network, etc.

As desired in various embodiments of the invention, one or more tones may be incorporated into or included in the broadcast signal that is received by the tone transmission device 510. The one or more tones may be incorporated into the broadcast signal by the broadcast entity 505 and/or by one or more intermediary systems 535, 540, 545, 550. For example, the broadcast entity 505 may insert, layer, embed, or otherwise incorporate one or more tones into a broadcast stream prior to or during the communication of the broadcast stream to a tone transmission device 510 or to an intermediary system 535, 540, 545, 550. The one or more tones may relate to, for example, products or services that are advertised via the broadcast stream (e.g., television or radio advertisement), programs included in the broadcast stream (e.g., television shows, movies, radio shows), etc. The incorporation of a tone into the broadcast stream may include the insertion of the tone into the broadcast stream utilizing a wide variety of different techniques and/or methods, for example, modulation, the insertion of a digital packet of information that includes the tone, the transmission of the tone in a separate channel or carrier signal, etc. Additionally, as desired in various embodiments of the invention, a tone may be incorporated into the broadcast stream as either an analog signal or as digital information.

With continued reference to FIG. 5, the system 500 may include one or more tone data sources 585. Each tone data source 585 may be operable to communicate or otherwise provide one or more tones and/or data associated with the generation of one or more tones to the broadcast entity 505 and/or an intermediary system 535, 540, 545, 550. In certain embodiments of the invention, a tone data source 585 may communicate tones and/or tone data to the broadcast entity 505 and/or an intermediary system 535, 540, 545, 550 via one or more suitable networks 560, for example, a local area network, a wide area network, the Internet, a telephone network, a broadcast network, a cellular network, any wired network, any wireless network, etc. In this regard, the broadcast entity 505 and/or an intermediary system 535, 540, 545, 550 may receive tones that are inserted into a broadcast signal and/or information that may be utilized to generate tones that are inserted into a broadcast signal. Tones and/or tone data may be communicated to the broadcast entity 505 and/or an intermediary system 535, 545, 545, 550 in response to the receipt, of a request for the tones and/or tone data. Alternatively, a data source 585 may push or otherwise communicate tones and/or tone data to the broadcast entity 505 and/or an intermediary system 535, 540, 545, 550 without the tones and/or tone data being requested. Each tone data source 585 may be a suitable processor driven device with components that are similar to the tone data sources 120 described above with reference to FIG. 1 and the tone data sources 210 described above with reference to FIG. 2.

Once the broadcast stream is received by the tone transmission device 510, the tone transmission device 510 may process and output at least a portion of the received broadcast stream via one or more suitable output devices 520, for example, one or more displays and/or speakers associated with the tone transmission device 510. A wide variety of tone transmission devices 510 may be utilized as desired in various embodiments of the invention, for example, a radio, television, projector, computer, etc. In certain embodiments of the invention, the broadcast stream may be processed and output in real time or near real time as it is received by the tone transmission device 510. In other embodiments of the invention, at least a portion of the broadcast stream may be stored in one or more suitable memory devices associated with the tone transmission device 510 (e.g., a digital video recorder), and the stored portion of the broadcast stream may be accessed from memory, processed, and/or output at a subsequent point in time.

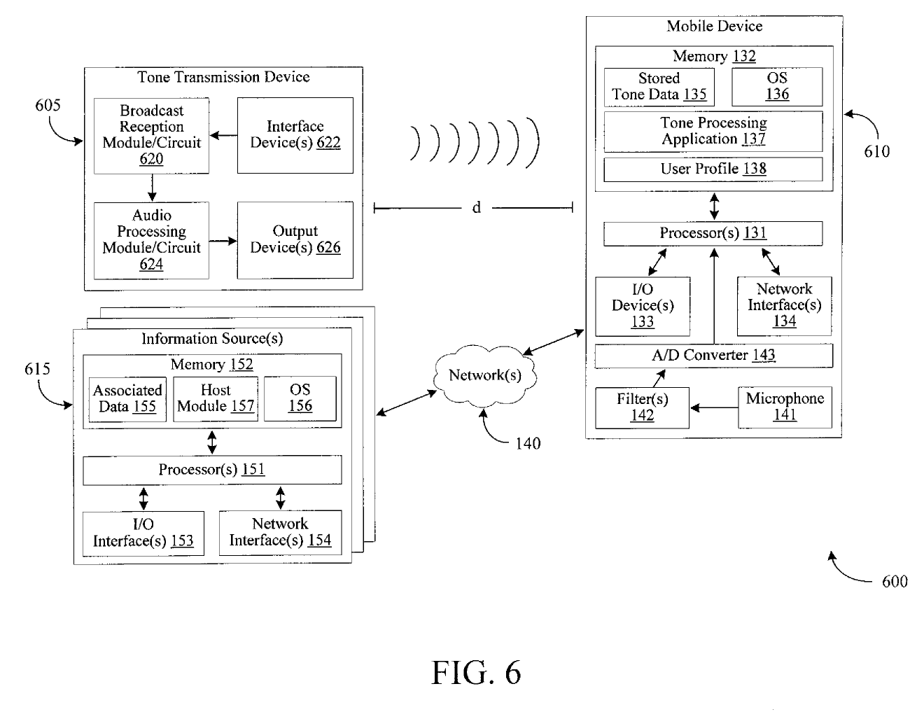

During the output ting of the broadcast stream by the tone transmission device 510, one or more tones included in the broadcast stream may be output. A mobile device 515 that is within a predetermined distance or range “d” from the tone transmission device 510 may be utilized to receive the one or more tones that are output, as described in greater detail below with reference to FIG. 6. The mobile device 515 may process one or more received tones in order to extract one or more location identifiers that are utilized to request and receive additional information associated with the one or more tones. In this regard, additional information associated with a broadcast stream, for example, advertising information, promotions, special offers, rebate information, coupons, rating information, etc., may be received by a mobile device 515 and presented to a user of the mobile device.

FIG. 6 is a schematic diagram of a system 600 that may facilitate the communication of information from a tone transmission device to a mobile device, according to an illustrative embodiment of the invention. The system 600 may be one example system that facilitates communication of one or more tones from the tone transmission device 510 of FIG. 5 to the mobile device 515 of FIG. 5.

With reference to FIG. 6, the system 600 may include a tone transmission device 605, a mobile device 610, and one or more information sources 615. The tone transmission device 605 may receive a broadcast signal from a broadcast entity or an intermediary system, for example, broadcast entity 505 or intermediary systems 535, 540, 545, 550 illustrated in FIG. 5. The tone transmission device 605 may process the received broadcast signal and output at least a portion of the received broadcast signal via one or more suitable output devices, for example, a display and/or one or more speakers. As desired in various embodiments of the invention, the output portion of the received broadcast signal may include one or more tones that may be received by a mobile device 610.

The tone transmission device 605 may be any suitable device that facilitates the receipt, of a broadcast signal and the output of at least a portion of the broadcast signal. The tone transmission device 605 may include, among other components, a broadcast reception module or broadcast reception circuit 620, one or more interface devices 622, an audio processing module or audio processing circuit 624, and one or more output devices 626.

The broadcast reception circuit 620 may facilitate the receipt of a broadcast signal by the tone transmission device 605. For example, the broadcast reception circuit 620 may facilitate the receipt of television signal or a radio signal by the tone transmission device 605. As desired in certain embodiments, the broadcast signal may be received by the tone transmission device 605 and communicated to the broadcast reception circuit 620 via one or more suitable interface devices 622 and/or input devices. Examples of suitable interface devices include, but are not limited to, antenna connections, cable television (CATV) connections, coaxial cable connections, other cable connections, S-Video connections, high-definition multimedia interface (HDMI) connections, and the like. In this regard, a broadcast signal may be received by a tone transmission device 605 for processing and/or output by the tone transmission device 605.

Once a broadcast signal is received by the tone transmission device 605, at least a portion of the broadcast signal may be processed and output, by the tone transmission device 605. For example, audio and/or video components of a broadcast signal may be processed and output by the tone transmission device 605. With reference to FIG. 6, the audio processing circuit 624 may process one or more audio components of the broadcast signal and format the one or more audio components to be output by the tone transmission device 605. In certain embodiments of the invention, digital audio data may be transformed or converted into analog audio data, for example, converting with a digital-to-analog converter, that may be output by the tone transmission device 605. In other embodiments of the invention, analog audio data may be parsed from the broadcast signal and output from the tone transmission device 605 through the audio processing circuit 624. The audio processing circuit 624 may process audio content in a wide variety of ways as desired in various embodiments of the invention. For example, the audio processing circuit 624 may amplify audio signals, filter audio signals, and/or distribute audio signals to a plurality of output devices. After being processed by the audio processing circuit 624, audio data associated with a broadcast signal may be output by one or more suitable output devices 626, for example, one or more suitable speakers associated with the tone transmission device 605. According to an aspect of the invention, one or more tones may be included in the received broadcast signal, and the one or more tones may be output for receipt by a mobile device 610.

In certain embodiments, one or more tones may be proactively output by the tone transmission device 605 for reception by a mobile device 610. For example, a tone may be output by the tone transmission device 605 during the output of the broadcast signal in which the tone is included. As desired in various embodiments, the tone may be output more than once by the tone transmission device 605 to increase the potential of the tone being received by the mobile device 610. For example, the tone may be output approximately 3 to approximately 5 times in succession or at predetermined time intervals, such as, every 5 seconds, every 10 seconds, every 15 seconds, etc. Additionally, as desired, an indication may be displayed, via one or more output devices of the tone transmission device 605 to a user, that a tone is available for receipt by a mobile device 610. For example, as a tone is being output, by the tone transmission device 605, a display associated with the tone transmission device 605 (e.g., radio or television display) may output an indication that a tone is being output. Such an indication may facilitate a user of the mobile device 610 configuring the mobile device 610 to receive tones. A wide variety of display or visual indicators may be utilized as desired in various embodiments of the invention, for example, a tone icon, a scrolling display, a pop-up display, etc. As another example, as a tone is being output by the tone transmission device 605, an audio indication that a tone is being output and is available for receipt by a mobile device 610 may be output by the tone transmission device 605.

In other embodiments, a tone may be output by the tone transmission device 605 in response to a request that is received from the mobile device 610. For example, a tone included in the broadcast signal may be identified by the tone transmission device 605 and stored in one or more suitable memories associated with the tone transmission device 605, such as, a random access memory, read only memory, etc. The tone may then be accessed from memory and communicated from the tone transmission device 605 to the mobile device 610 in response to a request for the tone that is received from the mobile device 610. Additionally, as desired, an indication that a tone is available may be displayed or otherwise output by the tone transmission device 605 to facilitate the requesting of the tone by the mobile device 610.

Embodiments of the invention may include tone transmission devices 605 with more or less than the components illustrated for the tone transmission device 605 illustrated in FIG. 6. For example, the tone transmission device 605 may include one or more suitable memory devices that facilitate the storage of at least a portion of a broadcast signal for subsequent access. Additionally, the tone transmission device 605 may be utilized in conjunction with or in association with a wide variety of other devices as desired in various embodiments of the invention. For example, if the tone transmission device 605 is a television, the tone transmission device 605 may be utilized in association with a satellite receiver, a cable receiver, a digital video recorder (DVR), and/or other devices. The description of the tone transmission device 605 of FIG. 6 is provided by way of example only and is not intended to be limiting.

With continued reference to FIG. 6, the mobile device 610 may be any suitable or appropriate device or system that facilitates the receipt of a tone from a tone transmission device 605 and the processing of the received tone. In this regard, the mobile device 610 may receive mobile marketing information and/or other information associated with a broadcast Signal through the receipt of one or more tones. Once a tone is received by the mobile device 610, the tone may be processed by the mobile device 610 to extract information included in the tone, such as, one or more location identifiers that reference additional information associated with the tone. The extracted information may be utilized to access one or more information sources 615 to obtain at least a portion of the additional information associated with the tone.

The mobile device 610 may have similar components to those of the mobile device 110 described above with reference to FIG. 1. Accordingly, the operation of the mobile device 610 may be similar to the mobile device 110 described above with reference to FIG. 1.

According to an aspect of the invention, the mobile device 610 may receive and process one or more tones that are output by a tone transmission device 605. A tone may be output by a tone transmission device 605 and the mobile device 610 may identity and receive the output tone within a predetermined distance or range “d” from the tone transmission device 605. A tone transmission device 605 may have a wide variety of different ranges as desired in various embodiments of the invention, for example, a range of approximately three feet. In certain embodiments of the invention, a tone processing application 137 of the mobile device 610 may control the receipt of tones by the mobile device 610. For example, a setting or option associated with the tone processing application 137 may control the receipt of tones by the mobile device 610. When a user indicates that the setting or option should be set to allow tones to be received, the receipt of tones may be facilitated by the mobile device 610. However, when a user indicates that the setting or option should be set to disallow the receipt of tones, then the mobile device 610 will not process any tones output by a tone transmission device 605. In some embodiments, tones may be received and processed when a user of the mobile device opens or executes the tone processing application 137. In other embodiments, tones may be received and processed when a user selects an option within the tone processing application 137 indicating that tones should be received.

During the processing of a received tone by the mobile device 610, one or more location identifiers may be extracted from the tone by the tone processing application 137. Once the one or more location identifiers have been extracted by the tone processing application 137, the tone processing application 137 may utilize the one or more location identifiers to receive additional information associated with the tone, for example, marketing information associated with the tone. The one or more location identifiers may facilitate the identification of one or more information sources 615 from which the additional information associated with the tone may be received. The tone processing application 137 may direct the communication of a request for the additional information to at least one information source 615 via a suitable network, such as a network similar to the network 140 discussed above with reference to FIG. 1. The request may include at least one location identifier and/or an identifier of the mobile device 610, for example, a telephone number associated with the mobile device 610, a universal integrated circuit card (UICC) identifier, a unique device identifier (UDID), a subscriber identity module (SIM) card identifier, an international mobile subscriber identity (IMSI) number associated with the mobile device 610, or any other identifier that facilitates communication with an information source (e.g., a First Data Mobile Gateway identifier). Responsive to the request, the mobile device 610 may receive the requested additional information associated with the tone via the network 140. The tone processing application 137 may process at least a portion of the received additional information. Additionally, the tone processing application 137 may direct the storage of the one or more location identifiers and/or the received additional information in the memory 132 of the mobile device 610. As desired, at least a portion of the received additional information may be presented or output to a user of the mobile device 610 via one or more suitable output devices associated with the mobile device 610, for example, a display, speaker, or an output device external to the mobile device 610.

Embodiments of the invention may include mobile devices 610 with more or less than the components illustrated for the mobile device 610 illustrated in FIG. 6. The description of the mobile device 610 of FIG. 6 is provided by way of example only and is not intended to be limiting.

With continued reference to FIG. 6, the system 600 may include any number of information sources 615 that are operable to provide additional information associated with tones to a mobile device 610. The additional information may be communicated to a mobile device 610 by an information source 615 in response to a request for the additional information, as discussed in greater detail above. In certain embodiments of the invention, a mobile device 610 may communicate requests directly to any number of information sources 615. In other embodiments, the mobile device 610 may communicate requests to a single information source or a central information source. The central information source may communicate with other information sources as desired in various embodiments of the invention and collect additional information that is communicated to the mobile device 610. Additionally or alternatively, the central information source may establish direct communication between the mobile device 610 and another information source, for example, via handing off a network session between the mobile device 110 and the central information source to another information source.

The components of the information source 615 illustrated in FIG. 6 may be similar to those of the information source 115 discussed above with reference to FIG. 1. Additionally, the communications between the mobile device 610 and the information source 615 may be similar to the communications between the mobile device 110 and the information source 115 discussed above with reference to FIG. 1.

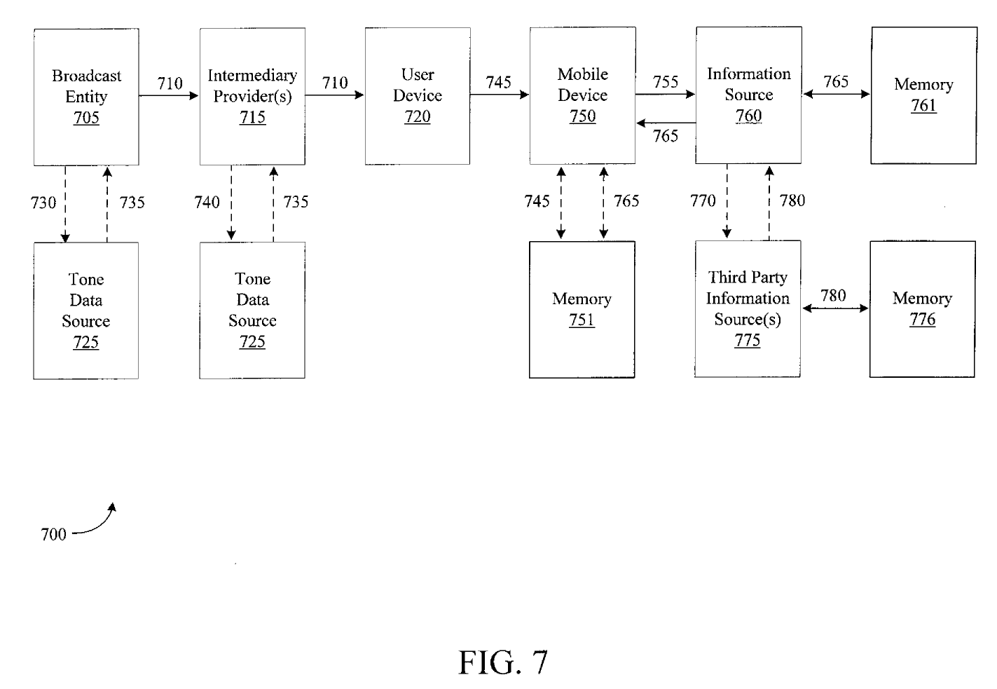

FIG. 7 is a diagram of another example data flow 700 of transmitting a tone included in a broadcast signal and retrieving information associated with the tone, according to an illustrative embodiment of the invention. Hie data flow 700 may be applicable to a systems utilized to communicate tones to a mobile device via a broadcast stream that is communicated to and output by a tone transmission device, including but not limited to, the system 600 illustrated in FIG. 6.

With reference to FIG. 7, a broadcast entity 705 may communicate a broadcast signal 710 or a broadcast stream to a tone transmission device 720. The broadcast signal 710 may be communicated directly to the tone transmission device 720 in certain embodiments of the invention. For example, a television, radio, or other broadcast signal may be communicated directly to the tone transmission device via one or more transmission towers associated with the broadcast entity 705. In other embodiments, the broadcast signal 710 may be communicated to the tone transmission device 720 through one or more intermediary providers 715. For example, a television, radio, or other broadcast signal may be communicated from the broadcast entity 705 to a satellite provider, cable provider, local provider, internet service provider, or IP television provider, and then communicated from the intermediary provider 715 to the tone transmission device 720. A wide variety of different networks, transmission systems, and/or communication means may be utilized as desired to facilitate the communication of the broadcast signal 710 from the broadcast entity 705 to an intermediary provider 715 and then to the tone transmission device 720.

One or more tones may be included in the broadcast signal 710 that is received by the tone transmission device 720. The one or more tones may be inserted by the broadcast entity 705 and/or by one or more intermediary providers 715. As desired in various embodiments of the invention, the broadcast entity 705 and/or the intermediary provider 715 may receive tone information 735 from one or more tone data sources 725. The tone information 735 may include one or more tones to be inserted into the broadcast signal 710 and/or information that may be utilized to generate one or more tones that are inserted into the broadcast signal 710. In certain example embodiments where tones are inserted, by the broadcast entity 705, the broadcast entity 705 may communicate a request 730 for tone information to one or more tone data sources 725, and the tone information 735 may be communicated to the broadcast entity 705 in response to the request 730. In other example embodiments where tones are inserted by the broadcast entity 705, one or more tone data sources 725 may push tone information 735 to the broadcast entity 705 without the tone information 735 being requested by the broadcast entity 705. Similarly, in certain example embodiments where tones are inserted by an intermediary provider 715, the intermediary provider 715 may communicate a request 740 for tone information to one or more tone data sources 725, and the tone information 735 may be communicated to the intermediary provider 715 in response to the request 740. In other example embodiments where tones are inserted by an intermediary provider 715, one or more tone data sources 725 may push tone information 735 to the intermediary provider 715 without the tone information 735 being requested by the intermediary provider 715. Communications between a tone data source 725 and the broadcast entity 705 and/or communications between a tone data source 725 and an intermediary provider 715 may be facilitated via one or more suitable networks as desired in various embodiments of the invention, for example, a local area network, a wide area network, the Internet, a telephone network, a broadcast network, a cellular network, any wired network, any wireless network, etc.

The tone transmission device 720 may receive the broadcast signal 710 and output at least a portion of the broadcast signal 710. A wide variety of tone transmission devices 720 may be utilized as desired in various embodiments of the invention, for example, a radio, television, projector, computer, etc. During the outputting of the broadcast signal 710 or a portion of the broadcast signal 710, the tone transmission device 720 may output one or more tones 745 included in the broadcast signal 710. For example, an audio portion of the broadcast signal 710 may be output by one or more speakers associated with the tone transmission device 720. During the output of the audio portion of the broadcast signal 710, a tone 745 may be output by the tone transmission device 720.

In certain embodiments of the invention, the tone 745 may be communicated from the tone transmission device 720 to a mobile device 750. In certain embodiments, the tone 745 may be proactively output by the tone transmission device 720 for reception by the mobile device 750. For example, the tone 745 may be output by the tone transmission device 720 during the output of the broadcast signal 710. As desired, the tone 745 may be output more than once by the tone transmission device 720 to increase the potential of the tone 745 being received by the mobile device 750. For example, the tone 745 may be output approximately 3 to approximately 5 times in succession or at predetermined time intervals, such as, every 5 seconds, every 10 seconds, every 15 seconds, etc. Additionally, as desired, an indication may be displayed, via one or more output devices of the tone transmission device 720 to a user, that a tone 745 is available for receipt by a mobile device 750. In other embodiments, the tone 745 may be output by the tone transmission device 720 in response to a request that is received from the mobile device 750. For example, a tone 745 included in the broadcast signal 710 may be identified by the tone transmission device 720 and stored in a suitable memory associated with the tone transmission device 720. The tone 745 may then be accessed from memory and communicated from the tone transmission device 720 to the mobile device 750 in response to a request for the tone 745 that is received from the mobile device 750.

After being output by the tone transmission device 720, the tone 745 may be received by the mobile device 750. According to an aspect of the invention, the tone 745 may be received by a microphone associated with the mobile device 750. After being received by a microphone, the tone 745 may be processed through one or more filters (e.g., band pass filters) as desired and converted into digital data utilizing an analog-to-digital converter. The digital data from the tone 745 may be processed by one or more appropriate software modules and/or software applications associated with the mobile device 750, for example, a tone processing application as described above with reference to FIGS. 1 and 2. One or more location identifiers may be extracted from the digital data by the mobile device 750. Additionally, as desired in various embodiments of the invention, the received tone 745, digital data and/or the one or more extracted location identifiers may be stored in one or more suitable memory devices 751 associated with the mobile device 750, for example, one or more caches, read only memory devices, random access memory devices, etc.

The mobile device 750 may utilize the one or more extracted location identifiers to request additional information associated with the tone 745 from one or more information sources 760. The mobile device 750 may generate a request 755 for additional information associated with the tone 745, and the mobile device 750 may communicate the request 755 to one or more information sources 760. The request 755 may include one or more of the extracted one or more location identifiers and an identifier of the mobile device 750, for example, a universal integrated circuit card (UICC) identifier, a unique device identifier (UDID), a subscriber identity module (SIM) card identifier, an international mobile subscriber identity (IMSI) number associated with the mobile device 750, or any other identifier that facilitates communication with an information source (e.g., a First Data Mobile Gateway identifier). In certain embodiments, the mobile device 750 may communicate with a central information source 760 when requesting additional information associated with a tone 745. In certain other embodiments, one or more of the location identifiers may identify one or more information sources that the mobile device 750 will communicate with to request additional information associated with a tone 745. In other embodiments, the mobile device 750 may initially communicate with a central information source 760 and a communication session may be passed off by the central information source 760 to another information source. In yet other embodiments, the mobile device 750 may initially communicate with a central information source 760 and the central information source 760 may establish communication sessions between the mobile device 750 and one or more other information sources. FIG. 7 illustrates the mobile device 750 communicating with a single information source 750 to request additional information associated with a tone 745; however, the mobile device 750 may communicate with any number of information sources 760, 775 as desired in other embodiments of the invention.

The request 755 for additional information associated with a tone 745 may be communicated from a mobile device 750 to an information source 760 via one or more suitable networks, for example, a cellular network, a local area network, a wide area network, the internet, a Bluetooth enabled network, a Wi-Fi network, a radio frequency network, any wired network, any wireless network, etc. The request 755 may be received and processed by the information source 760. The information source 760 may utilize one or more of the location identifiers to access additional information 765 associated with the tone 745 from any number of suitable memory devices 761 associated with the information source 760, for example, caches, read only memory devices, random access memory devices, magnetic storage devices, databases, etc. As an example, if the tone 745 is associated with a product, the information source 760 may utilize one or more location identifiers extracted from the tone 745 to access advertising, marketing, promotional, discount and/or rebate information associated with the product.

Additionally, in certain embodiments of the invention, the information source 760 may communicate a request 770 for additional information associated with the tone 745 to one or more third party information sources 775. The one or more third party information sources 775 may be identified by the information source 760 from one or more of the location identifiers extracted from the tone 745 by the mobile device 750. The request 770 that is communicated to the one or more third party information sources 775 may include one or more location identifiers extracted from the tone 745 and/or an identifier of the information source 760. Communication between the information source 760 and the one or more third party information sources 775 may be facilitated via one or more suitable networks, for example, a local area network, a wide area network, the Internet, any wired network, any wireless network, etc.

A third party information source 775 may receive and process a request 770 for additional information from the information source 760. The third party information source 775 may utilize one or more of the location identifiers to access additional information 780 associated with the tone 745 from any number of suitable memory devices 776 associated with the third party information source 776, for example, caches, read only memory devices, random access memory devices, magnetic storage devices, databases, etc. The third party information source 775 may then communicate the accessed additional information 780 to the information source 760 via the one or more suitable networks in response to the request 770. The information source 760 may receive the additional information 780 from the third party information source 775. In some embodiments, additional information 780 may be received by the information source 760 from multiple third party information sources 775, and the information source 775 may combine the received additional information 780 to generate the additional information 765 that will be communicated to the mobile device 750. Additionally, as desired in various embodiments, additional information 780 received from thud party information sources 775 may be combined with additional information accessed by the information source 760. When combining information received and/or accessed from various sources, the information source 760 may extract duplicate information and/or resolve conflicts between conflicting information as desired in various embodiments. In this regard, the additional information 765 to be communicated to the mobile device 750 may be formatted for communication to the mobile device 750.

Once the additional information 765 associated with the tone 745 has been accessed and/or received by the information source 760, the information source 760 may communicate the additional information 765 to the mobile device 750 in response to the request 755 for additional information that was received from the mobile device 750. The mobile device 750 may receive the additional information 765 from the information source 760. As desired in various embodiments, the mobile device 750 may store a portion or all of the received additional information 765 in memory 751.

Additionally, as desired in various embodiments, the mobile device 750 may display at least a portion of the additional information 765 to a user of the mobile device 750 via one or more suitable output devices, for example, a display. As an example, advertising information, promotions, special offers, and/or coupons for a product associated with the tone 745 may be displayed to the user. In certain embodiments, the mobile device 750 may utilize at least a portion of the additional information 765 to communicate with another entity. For example, the additional information 765 may include a link, such as a hyperlink, that facilitates the establishment of communication between the mobile device 750 and another entity, such as, an information source 760, 775, or another entity, system, or device associated with the tone 745. In this regard, the mobile device 750 may be utilized to access other information associated with the tone 745, for example, a web site that includes information associated with the tone 745. The mobile device 750 may also be utilized to communicate user preferences and/or other user input information associated with the tone 745 and/or the additional information 765. For example, a user may enter a rating for a product, radio show, television show, etc. that is associated with the tone 745, and the input rating information may be communicated to one or more other entities, such as, an information source 760, 775, a distributor of a product, a manufacturer of a product a retailer of a product, a broadcaster of a show, etc.

Many variations may be made to the data flow 700 illustrated in FIG. 7 as desired in various embodiments of the invention. The data flow 700 is not intended to be limiting, but instead is provided by way of example only as an illustrative embodiment of the invention.

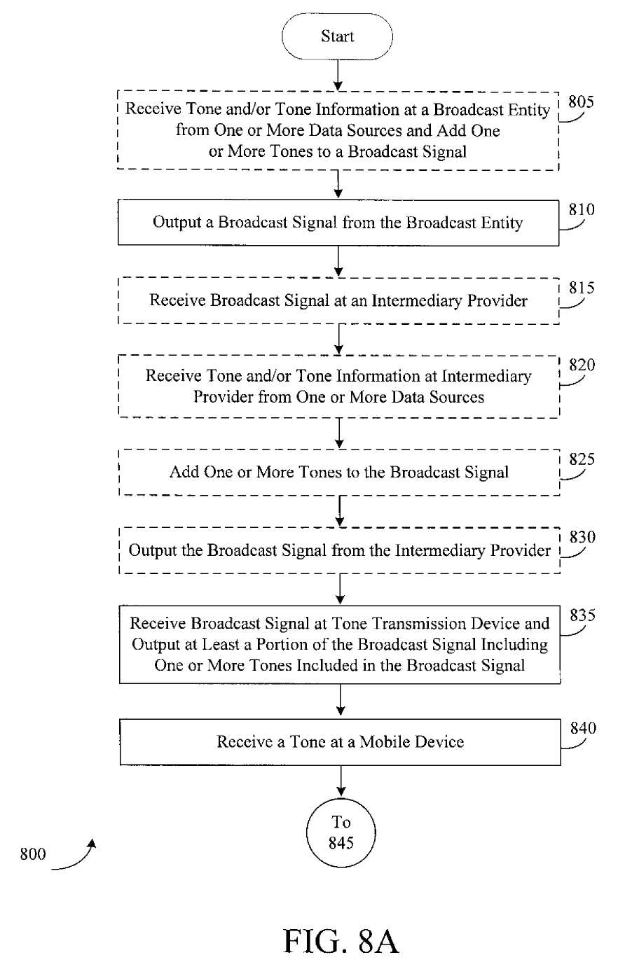

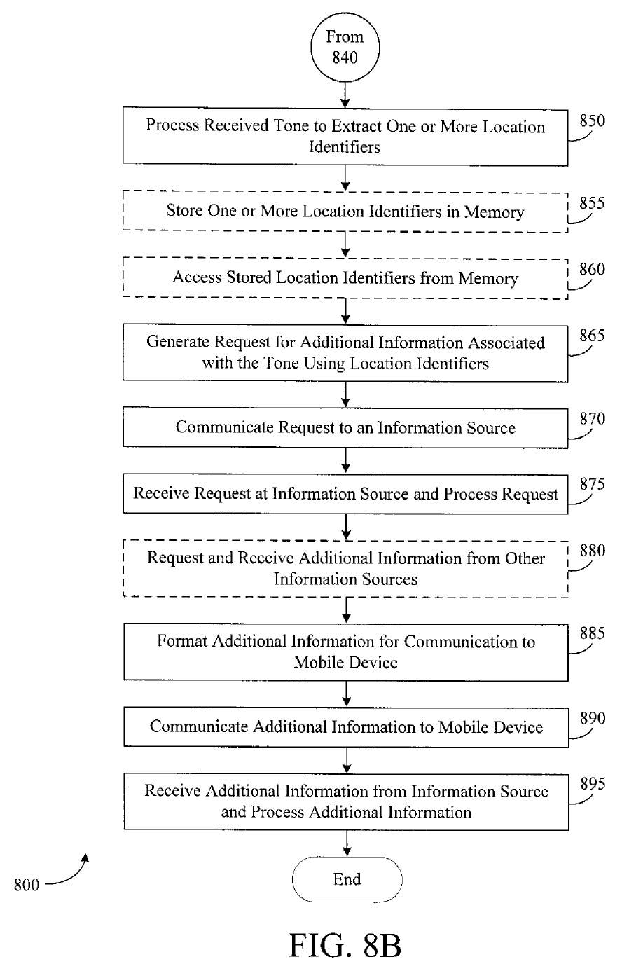

FIGS. 8A and 8B are flow charts of one example method 800 of communicating information to a mobile device through one or more tones included in a broadcast Signal, according to an illustrative embodiment of the invention. The method 800 may include various operations that are performed by a broadcast entity, an intermediary provider, a tone transmission device, a mobile device, and/or an information source as desired in various embodiments of the invention. Additionally, the method 800 may include communicating a tone to a mobile device and processing the received tone at the mobile device to facilitate requesting additional information associated with the tone.

The method 800 may begin at block 805. At block 805, which may be optional in certain embodiments of the invention, one or more tones and/or tone information may be communicated to a broadcast entity, for example, the broadcast entity 705 illustrated in FIG. 7 from one or more data sources or tone data sources, for example, the one or more tone data sources 725 illustrated in FIG. 7. The one or more tones and/or tone information may be received by the broadcast entity 705 and utilized to incorporated or insert one or more tones into a broadcast signal that is output by the broadcast entity 705. The communication between the broadcast entity 705 and the one or more data sources 725 may be facilitated via one or more suitable networks as desired in various embodiments of the invention.

At block 810, the broadcast entity 705 may output a broadcast signal. The output broadcast signal may include one or more tones in various embodiments of the invention in which one or more tones are incorporated into or inserted into the broadcast signal by the broadcast entity 705.

At block 815, which may be optional in certain embodiments of the invention, the broadcast signal may be received by an intermediary provider, for example, the intermediary provider 715 described above with reference to FIG. 7. The intermediary provider 715 may facilitate communicating the broadcast signal on to a tone transmission device for output to a user.

At block 820, which may be optional in certain embodiments of the invention, one or more tones and/or tone information may be communicated to the intermediary provider 715 from one or more data sources or tone data sources 725. The one or more tones and/or tone information may be received by the intermediary provider 715 and utilized to incorporated or insert, one or more tones into the broadcast signal at block 825, which may be optional in certain embodiments of the invention. The communication between the intermediary provider 715 and the one or more data sources 725 may be facilitated via one or more suitable networks as desired in various embodiments of the invention.

At block 830, which may be optional in certain embodiments of the invention, the broadcast, signal may be output by the intermediary provider 715 for receipt by another intermediary provider 715 or by a tone transmission device, such as tone transmission device 720 described above with reference to FIG. 7. Although any number of intermediary providers 715 may be utilized in various embodiments of the invention, the broadcast signal, will eventually be output for communication to a tone transmission device 720. Additionally, in embodiments of the invention in which no intermediary providers 715 are utilized, the broadcast signal may be communicated from the broadcast entity 705 directly to the tone transmission device 720.

At block 835, the broadcast signal may be received by the tone transmission device 720. The broadcast signal received by the tone transmission device 720 may include one or more tones. The tone transmission device 720 may process and output at least a portion of the received broadcast signal, in this regard, the one or more tones included in the broadcast signal may be output by the tone transmission device 720. The one or more tones may be output by any number of suitable output devices associated with the tone transmission device 720, for example, by one or more speakers associated with the tone transmission device 720. In certain embodiments, analog data associated with a tone may be received by the tone transmission device 720 in a broadcast signal, and the analog data may be output by the tone transmission device 720. In other embodiments, digital data representing a tone may be received by the tone transmission device 720, and the received digital data may be passed through one or more digital-to-analog converters and transformed or converted into analog data for the tone. The analog data may then be output by one or more suitable output devices associated with the tone transmission device 720, for example, one or more speakers.

At block 840, one or more tones output by the tone transmission device 720 may be received at a mobile device, for example, mobile device 750 illustrated in FIG. 7. The one or more tones may be received by one or more suitable input devices associated with the mobile device 750, for example, a microphone associated with the mobile device 750. In certain embodiments, a tone may be picked up by a microphone if the mobile device 750 is within a certain range of the tone transmission device 720, for example, within approximately two to approximately six feet. After being picked up by a microphone or other input device, the tone may be passed through one or more filters, for example, one or more band pass fibers, to filter out noise, and the tone may then be transformed or converted into a digital representation of the tone utilizing one or more analog-to-digital converters associated with the mobile device 750. As desired in various embodiments, further filtering may be conducted on the digital representation of the tone utilizing one or more digital and/or software filters. For purposes of completing the description of FIG. 8, the digital representation of a tone may be referred to as a tone.

At block 845, the received tone may be processed by the mobile device 750 in order to extract one or more location identifiers included in the received tone. The one or more location identifiers may identify one or more data sources and/or one or more memory locations at the one or more data sources at which additional information associated with the received tone is stored. A location identifier for a data source may be utilized to identify an information source, such as information source 760 or information source 775, that is contacted to obtain additional information associated with a tone. A location identifier for a memory location may be communicated to a data source and utilized by the data source to identify additional information associated with a tone that is stored at the data source. After the one or more location identifiers are extracted by the mobile device 750. The mobile device 750 may store the extracted one or more location identifiers in memory at block 855, which may be optional in certain embodiments of the invention. Additionally, at block 860, which may be optional in certain embodiments of the invention, the stored one or more location identifiers may be accessed from memory and utilized in the generation of a request for additional information associated with the tone.

At block 865, the mobile device 750 may generate a request for additional information associated with one or more received tones. As desired in various embodiments of the invention, a portion or all of the extracted location identifiers may be utilized in the generation of the request. For example, a location identifier for an information source 760, 775 may be utilized to identify an information source 760, 775 to send a request for additional information to. In this regard, a generated request may be addressed to an identified information source 760, 775 that processes the request. Additionally, a portion or all of the extracted location identifiers may be included in a generated request. Location identifiers for memory location may facilitate the retrieval or access, by an information source 760, 775 of stored additional information associated with a tone. Location identifiers associated with identified information sources may facilitate a first information source 760 communicating with a second information source 775 to request additional information associated with a tone and/or to establish communication between the second information source 775 and the mobile device 775.

In addition to one or more location identifiers, a generated request for additional information may include an identifier of the mobile device 750, for example, a telephone number associated with the mobile device 750, a universal integrated circuit card (UICC) identifier, a unique device identifier (UDID), a subscriber identity module (SIM) cad identifier, an international mobile subscriber identity (IMSI) number associated with the mobile device 750, or any other identifier that facilitates communication with an information source (e.g., a First Data Mobile Gateway identifier). In this regard, the mobile device 750 may be identified by an information source 760, 775 for responding to a generated request.

The mobile device 750 may communicate requests for additional information associated with a tone to a wide variety of different information sources as desired in various embodiments of the invention. Additionally, as desired in various embodiments of the invention, an information source may process a received request for additional information in a wide variety of different manners. A few non-limiting examples of the communication and processing of requests for additional information are discussed above with reference to FIGS. 4A and 4B. For purposes of describing FIGS. 8A and 8B, it will be assumed that the mobile device 750 communicates a request for additional information to a central information source, such as information source 760 illustrated in FIG. 7.

With continued reference to FIG. 8, the mobile device 750 may communicate a generated request for additional information to the information source 760 at block 870. The request may be communicated over a wide variety of different networks and/or utilizing a wide variety of different techniques as desired in various embodiments of the invention. Examples of suitable networks that may be utilized include, but are not limited to, a cellular network, a local area network, a wide area network, the Internet a Bluetooth enabled network, a Wi-Fi network, a radio frequency network, any wired network, any wireless network, etc. Examples of suitable programs, techniques, and/or methods for communicating a generated request to an information source 760 include, but are not limited to, communicating a request via a SMS message, communicating a request via a web site hosted by the information source 760 and accessed by a mobile Internet browser, etc.

The request for additional information may be received and processed by the information source 760 at block 875. During the processing of the request the information source may access one or more suitable memory devices utilizing one or more location identifiers included in the received request. As explained in greater detail above, certain location identifiers may reference a specific memory location or a block of memory at which additional information associated with a tone is stored. These location identifiers may be utilized by the information source 760 to access the referenced memory and retrieve the additional information associated with the tone.

At block 880, which may be optional in certain embodiments of the invention, the information source 760 may communicate one or more requests for additional information associated with a tone to one or more additional information sources, for example, the one or more third party information sources 775 shown in FIG. 7, and additional information may be received by the information source 760 in response to the one or more requests. The information source 760 may generate a request to be sent to a third party information source 775 in a similar manner as that in winch a request is generated by the mobile device 750. Additionally, a request may be processed by a third party information source 775 in a similar manner as that in which a request is processed by the information source 760. Communications between the information source 760 and the one or more third party information sources 775 may be facilitated via any number of suitable networks, for example, a cellular network, a local area network, a wide area network, the Internet, any wired network, any wireless network, etc. In this regard, additional information associated with a tone may be collected and combined at the information source 760 before being communicated to the mobile device 750. Although the example above discusses the collection of additional information at a single information source 760, other embodiments of the invention may include the direct communication of additional information to the mobile device 750 from any number of information sources.

At block 885, the information source 760 may format the additional information associated with a tone for communication to the mobile device 750. If additional information is received from multiple sources, then the additional information may be consolidated and any duplicate information may be identified and eliminated. Further, the additional information may be formatted into one or more suitable communication packets and/or communication streams for transmission to the mobile device 750.

The additional information may be communicated by the information source 760 to the mobile device 750 at block 890 and received by the mobile device at block 895. The communication may be facilitated via any number of suitable networks and/or utilizing any suitable method and/or technique, as discussed in greater detail above.

Additionally, at block 895, once the additional information is received by the mobile device 750, the mobile device 750 may process the received additional information in a wide variety of different manners as desired in various embodiments of the invention. For example, at least a portion of the additional information may be displayed to a user of the mobile device 750 via one or more suitable output devices, such as, a suitable display. In this regard, advertising information, special offers, rebates, coupons, and other types of information may be presented to the user. Additionally, in various embodiments of the invention, a portion or all of the received additional information may be stored by the mobile device 750 in one or more suitable memory devices.

The method 800 may end following block 895.

The operations described and shown in the method 800 of FIGS. 8A and 8B may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 8A and 8B may be performed.

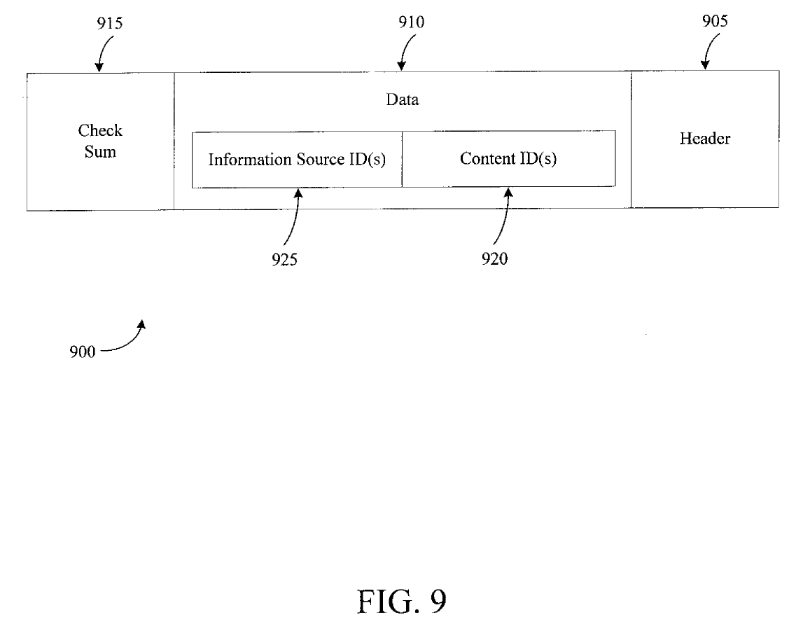

The communication of one or more tones to a mobile device may facilitate the receipt of various type of information, such as advertising and rating information, at the mobile device. In various embodiments of the invention, a tone may include information, for example, one or more location identifiers, that facilitates the requesting of additional information by the mobile device. FIG. 9 is a block diagram of data that may be included in an example tone 900, according to an illustrative embodiment of the invention.

With reference to FIG. 9, the tone 900 may include a header portion 905, a data portion 910, and/or a check sum portion 915. The header portion 905 may include, for example, information that identifies the tone 900 and the information and/or data that is included in the tone 900. The data portion 910 may include a data pay load, for example, one or more location identifiers, that may be received by a mobile device and extracted from the tone 900. Any number of location identifiers may be included in the data, portion 910 as desired in various embodiments of the invention. Additionally, content identifiers 920 and/or information source identifiers 925 may be included in the data portion 910 as desired. A content identifier 920 may identify, reference, or point to a memory location or block of memory at which additional information associated with the tone 900 is stored at an information source. An information source identifier 925 may identify, reference, or point to an information source at which additional information associated with the tone 900 is stored. The check sum portion 915 may include suitable information and/or data that may be utilized by a receiving mobile device to verify that the tone 900 has been properly received.

The tone 900 described with reference to FIG. 9 illustrates one example of the information or data that may be included in a tone 900 that is utilized in various embodiments of the invention. A wide variety of other information and/or information formats may be utilized to form a tone as desired in various embodiments of the invention. The tone 900 of FIG. 9 is provided by way of example only and is not intended to be limiting.

Although the tone 900 is described as including one or more location identifiers in the data portion 910, a wide variety of different data and types of data may be included in the data portion 910. The examples of a tone 900 including one or more location identifiers that are set forth in this description are not intended to be limiting but are provided by way of example only. Other data and/or types of data may be included in a tone as desired in various embodiments of the invention. Additionally, in certain embodiments, one or more tones may be utilized to directly communicate information between a transmitting device and a receiving device. For example, a message may be communicated directly to a receiving device via a plurality of tones.

Additionally, when a tone is output to a mobile device by a tone generation device, for example, an advertisement tone generation device, a tone transmission device, another mobile device, or any other suitable device, the tone may be output as an analog signal. In certain embodiments of the invention, analog data for a tone may be received or accessed from memory by a tone generation device, and the analog data may be output for receipt by a mobile device. In other embodiments of the invention, digital data for a tone may be received or accessed from memory by a tone generation device, and the digital data may be transformed into analog data and output, for receipt by a mobile device. A tone may be output utilizing a wide variety of signals as desired in various embodiments of the invention. For example, in certain embodiments, the information carried in a tone may be added to a base or carrier signal by modulating the base signal.

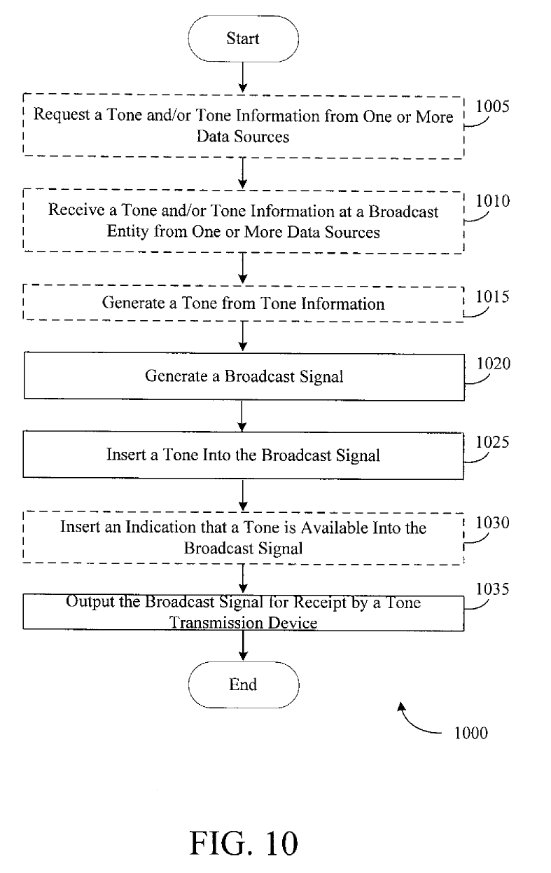

FIG. 10 is a flow chart of one example method 1000 for incorporating one or more tones into a broadcast signal by a broadcast entity, according to an illustrative embodiment of the invention. The method 1000 may include various operations that are performed by a broadcast entity, such as a television or radio broadcast entity, as desired in various embodiments of the invention.

The method may begin at block 1005. At block 1005, which may be optional in various embodiments of the invention, a broadcast entity, for example, the broadcast entity 505 illustrated in FIG. 5, may communicate a request for one or more tones and/or tone information to one or more tone data sources, such as the one or more tone data sources 585 illustrated in FIG. 5. The request may be communicated to the one or more tone data sources 585 via any number of suitable networks as desired in various embodiments of the invention, such as, a local area network, wide area network, cellular network, radio frequency network, Bluetooth network, Wi-Fi network, the Internet, etc.

At block 1010, one or more tones and/or tone information that may be utilized to generate a tone may be received by the broadcast entity 505. In certain embodiments, the one or more tones and/or tone information may be received via one or more suitable network connections, for example, a direct network connection (e.g., a wired network connection to a personal computer), a local area, network connection, a wide area network connection, a cellular network connection, a radio frequency network connection, a Bluetooth network connection, a Wi-Fi network connection, etc. In other embodiments, the one or more tones and/or tone information may be received via one or more suitable input devices associated with the broadcast entity 505. For example, a tone and/or tone information may be received from a portable memory device, such as, a memory stick, a CD-ROM, a flash drive, memory card, etc. As yet another example, tone information that may be utilized to generate a tone may be received by a user inputting the tone information via one or more suitable input devices associated with the broadcast entity 505, for example, a keypad, keyboard, mouse, touch screen, microphone, etc. In certain embodiments, one or more tones and/or tone information may be received from one or more tone data sources 585 in response to a request communicated to the one or more tone data sources 585. In other embodiments, one or more tones and/or tone information may be pushed to the broadcast entity 505 by the one or more tone data sources 585.

At block 1015, which may be optional in various embodiments of the invention, at least a portion of received, input, and/or prestored tone information may be utilized to generate a tone at the broadcast entity 505. For example, at least a portion of the tone information may be utilized to generate digital data that represents a tone, for example, to generate a WAV file, MP3 file, etc.

At block 1020, a broadcast signal, such as a television signal or a radio signal, may be generated by the broadcast entity 505. According to an aspect of the invention, the generated broadcast signal may include an audio component that will ultimately be output to a user.

At block 1025, the broadcast entity 505 may insert at least one tone into the broadcast signal. A wide variety of techniques may be utilized to insert, at least one tone into a broadcast signal as desired in various embodiments of the invention. For example, a tone may be inserted into the audio component of a broadcast signal. As another example, a tone may be added to a component of a broadcast signal other than an audio component of a broadcast signal, such as, a video component, some other component, or a separate channel of the broadcast signal.

At block 1030, which may be optional in various embodiments of the invention, an indication that a tone is available may be inserted into the broadcast signal. The indication that a tone is available may be output to a user to indicate that a tone is being output or will soon be output for reception by a mobile device of the user. A wide variety of different types of indications may be utilized as desired in various embodiments of the invention. For example, an icon or other visual indicator may be added to a video component, or other component of the broadcast signal for display to a user. The icon or other visual indicator may be displayed to the user via one or more suitable output devices associated with a tone transmission device, for example, a television display, an LCD display associated with a radio, etc. As another example, a suitable audio indicator may be added to the broadcast signal for output to a user.

At block 1035, the broadcast signal may be transmitted or otherwise output by the broadcast entity 505 for ultimate receipt by a tone transmission device and presentation to a user. In certain embodiments, the broadcast signal may be directly communicated to a tone transmission device by the broadcast entity 505, for example, by the broadcast signal being output by one or more transmission towers for reception by the tone transmission device. In other embodiments, the broadcast signal may be communicated to one or more intermediary providers, for example, satellite providers, cable providers, local providers, IP television providers, internet service providers, etc., that are then operable to communicate the broadcast signal to the tone transmission device.

The method 1000 may end following block 1035.

The operations described and shown in the method 1000 of FIG. 10 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 10 may be performed.

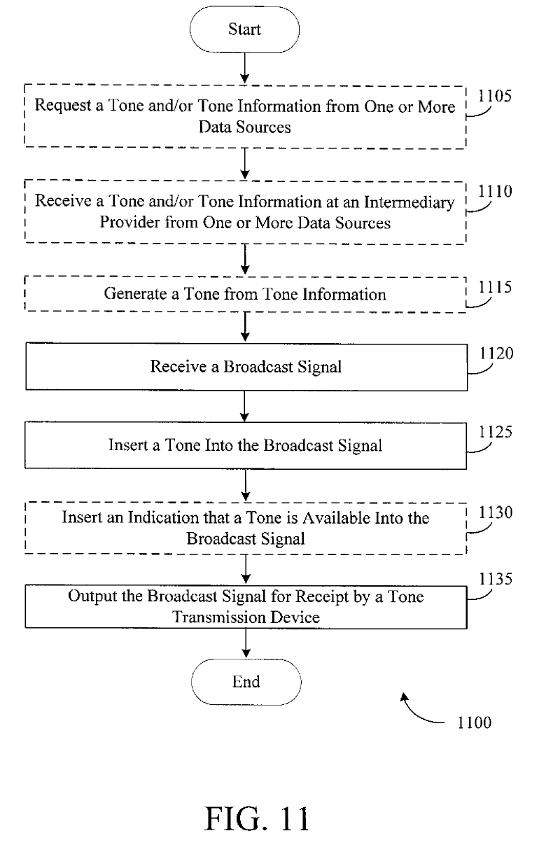

FIG. 11 is a flow chart of one example method 1100 for incorporating one or more tones into a broadcast signal by an intermediary provider, according to an illustrative embodiment of the invention. The method 1100 may include various operations that are performed by an intermediary providers, such as a satellite provider, cable provider, local provider, IP television provider, Internet service provider, etc., as desired in various embodiments of the invention.

The method may begin at block 1105. At block 1105, which may be optional in various embodiments of the invention, an intermediary provider, for example, the intermediary provider 535 illustrated in FIG. 5, may communicate a request for one or more tones and/or tone information to one or more tone data sources, such as the one or more tone data sources 585 illustrated in FIG. 5. The request may be communicated to the one or more tone data sources 585 via any number of suitable networks as desired in various embodiments of the invention, such as, a local area network, wide area network, cellular network, a radio frequency network, the Internet, etc.

At block 1110, one or more tones and/or tone information that may be utilized to generate a tone may be received by the intermediary provider 535. In certain embodiments, the one or more tones and/or tone information may be received via one or more suitable network connections, for example, a direct network connection (e.g., a wired network connection to a personal computer), a local area network connection, a wide area network connection, a cellular network connection, a radio frequency network connection, etc. In other embodiments, the one or more tones and/or tone information may be received via one or more suitable input devices associated with the intermediary provider 535. For example, a tone and/or tone information may be received from a portable memory device, such as, a memory stick, a CD-ROM, a flash drive, memory card, etc. As yet another example, tone information that may be utilized to generate a tone may be received by a user inputting the tone information via one or more suitable input devices associated with the intermediary provider 535, for example, a keypad, keyboard, mouse, touch screen, microphone, etc. In certain embodiments, one or more tones and/or tone information may be received from one or more tone data sources 585 in response to a request communicated to the one or more tone data sources 585. In other embodiments, one ore more tones and/or tone information may be pushed to the broadcast entity 505 by the one or more tone data sources 585.

At block 1115, which may be optional in various embodiments of the invention, at least a portion of received, input, and/or prestored tone information may be utilized to generate a tone at the intermediary provider 535. For example, at least a portion of the tone information may be utilized to generate digital data that represents a tone, for example, to generate a WAV file, MP3 file, etc.

At block 1120, a broadcast signal, such as a television signal or a radio signal, may be received by the intermediary provider 535. For example, a broadcast signal may be received from a broadcast entity, such as the broadcast entity 505 illustrated in FIG. 5. As another example, a broadcast signal may be received from another intermediary provider. According to an aspect of the invention, the received broadcast signal may include an audio component that will ultimately be output to a user.

At block 1125, the intermediary provider 535 may insert at least one tone into the broadcast signal. A wide variety of techniques may be utilized to insert at least one tone into a broadcast signal as desired in various embodiments of the invention. For example, a tone may be inserted into the audio component of a broadcast signal. As another example, a tone may be added to a component of a broadcast signal other than an audio component of a broadcast signal, such as, a video component, some other component, or a separate channel of the broadcast signal.

At block 1130, which may be optional in various embodiments of the invention, an indication that a tone is available may be inserted into the broadcast signal. The indication that a tone is available may be output to a user to indicate that a tone is being output or will soon be output for reception by a mobile device of the user. A wide variety of different types of indications may be utilized as desired in various embodiments of the invention. For example, an icon or other visual indicator may be added to a video component or other component of the broadcast signal for display to a user. The icon or other visual indicator may be displayed to the user via one or more suitable output devices associated with a tone transmission device, for example, a television display, an LCD display associated with a radio, etc. As another example, a suitable audio indicator may be added to the broadcast signal for output to a user.

At block 1135, the broadcast signal may be transmitted or otherwise output by the intermediary provider 535 for ultimate receipt by a tone transmission device and presentation to a user. In certain embodiments, the broadcast signal may be directly communicated to a tone transmission device by the intermediary provider 535, for example, by the broadcast signal being transmit to the tone transmission device via one or more suitable transmission towers and/or the broadcast signal being communicated to the tone transmission device via a satellite network, a cable network, a wide area network, the Internet, etc. In other embodiments, the broadcast signal may be communicated to one or more other intermediary providers that are then operable to communicate the broadcast signal to the tone transmission device.

The method 1100 may end following block 1135.

The operations described and shown in the method 1100 of FIG. 11 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 11 may be performed.

Accordingly, example embodiments of the invention can provide the technical effects of creating a system, method, and apparatus that provides one or more information carrying tones to a mobile device via a broadcast signal. The information carrying tones may be associated with a wide variety of information, such as, marketing or advertisement information. Additionally, the information earning tones may include one or more location identifiers that may be utilized to access additional information associated with the tones. In this regard, example embodiments of the invention can provide the technical effects of providing marketing, advertisement, or other information to a mobile device.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, sand computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for communicating information to a mobile device, the method comprising:
inserting a tone into a broadcast signal, the tone comprising at least one location identifier for information associated with the tone; and
outputting the broadcast signal for communication to a tone transmission device operable to communicate the tone to a mobile device,
wherein the at least one location identifier facilitates the receipt, by the mobile device from an information source, of the information associated with the tone.

2. The method of claim 1, further comprising:
generating the broadcast signal prior to inserting the tone into the broadcast signal.

3. The method of claim 1, further comprising:
receiving the broadcast signal from a separate entity prior to inserting the tone into the broadcast signal.

4. The method of claim 1, wherein inserting a tone into a broadcast signal comprises inserting a tone into an audio component of the broadcast signal.

5. The method of claim 1, wherein the at least one location identifier comprises multiple location identifiers,
wherein a first of the multiple location identifiers facilitates communication between the mobile device and the information source, and
wherein a second of the multiple location identifiers facilitates communication between the information source mid mi additional information source.

6. The method of claim 1, wherein the tone transmission device comprises a television or a radio.

7. The method of claim 1, further comprising:
receiving the tone from a data source prior to inserting the tone into the broadcast signal.

8. The method of claim 1, further comprising generating the tone prior to inserting the tone into the broadcast signal.

9. A broadcast signal provider, comprising:
at least one output device operable to transmit a broadcast signal for receipt by a tone transmission device; and
at least one processor operable to insert a tone into the broadcast signal and to direct the at least one output device to transmit the broadcast signal, wherein the tone comprises at least one location identifier for information associated with the tone the transmission of the tone by the at least one output device,
wherein the tone transmission device is operable to receive the broadcast signal with the tone and output the tone to a mobile device, and
wherein the at least one location identifier facilitates the receipt, by the mobile device from an information source, of the information associated with the tone.

10. The broadcast signal provider of claim 9, wherein the at least one processor is further operable to generate the broadcast signal prior to inserting the tone into the broadcast signal.

11. The broadcast signal provider of claim 9, further comprising:
a communications interface operable to receive the broadcast signal from a separate entity prior to the at least one processor inserting the tone into the broadcast signal.

12. The broadcast signal provider of claim 9, wherein the at least one processor is operable to insert the tone into an audio component of the broadcast signal.

13. The broadcast signal provider of claim 9, wherein the at least one location identifier comprises multiple location identifiers,
wherein a first of the multiple location identifiers facilitates communication between the mobile device and the information source, and
wherein a second of the multiple location identifiers facilitates communication between the information source and an additional information source.

14. The broadcast signal provider of claim 9, wherein the tone transmission device comprises a television or a radio.

15. The broadcast signal provider of claim 9, further comprising;
a communications interface operable to receive the tone from a data source prior to the at least one processor inserting the tone into the broadcast signal.

16. The broadcast signal provider of claim 9, wherein the at least one processor is further operable to generate the tone prior to inserting the tone into the broadcast signal.

17. A method for communicating information to a mobile device, the method comprising;
receiving, from a data source, tone data that facilitates the generation of a tone;
generating, utilizing at least a portion of the received tone data, a tone for insertion into a broadcast signal, the tone comprising at least one location identifier for information associated with the tone;
inserting a tone into the broadcast signal;
outputting the broadcast signal for communication to a tone transmission device, the tone transmission device operable to communicate the tone to a mobile device,
wherein the at least one location identifier facilitates the receipt, by the mobile device from an information source, of the information associated with the tone.

18. The method of claim 17, further comprising;
generating the broadcast signal prior to inserting the tone into the broadcast signal.

19. The method of claim 17, further comprising;
receiving the broadcast signal from a separate entity prior to inserting the tone into the broadcast signal.

20. The method of claim 17, wherein inserting a tone into a broadcast signal comprises inserting a tone into an audio component of the broadcast signal.
